(19) United States
(12) Patent Application Publication
(10) Pub. No.: US 2024/0411417 A1
(43) Pub. Date: Dec. 12, 2024

(54) ELECTRONIC DEVICE AND METHOD FOR CONTROLLING EXTERNAL ELECTRONIC DEVICE USING THE SAME

(71) Applicant: Samsung Electronics Co., Ltd., Suwon-si (KR)

(72) Inventors: Heekyung MOON, Suwon-si (KR); Haeree NA, Suwon-si (KR); Wanje PARK, Suwon-si (KR); Jinwan AN, Suwon-si (KR); Junhee CHO, Suwon-si (KR)

(21) Appl. No.: 18/784,031

(22) Filed: Jul. 25, 2024

Related U.S. Application Data
(63) Continuation of application No. PCT/KR2024/007829, filed on Jun. 7, 2024.

(30) Foreign Application Priority Data
Jun. 7, 2023 (KR) 10-2023-0073107
Aug. 9, 2023 (KR) 10-2023-0104065

(51) Int. Cl. G06F 3/0481; G06F 9/451

(52) U.S. Cl. CPC G06F 3/0481; G06F 9/451

(57) ABSTRACT

An electronic device is provided. The electronic device includes a communication circuit, a display, memory storing one or more computer programs, one or more processors communicatively coupled to the communication circuit, the display, and the memory, wherein the one or more computer programs include computer-executable instructions that, when executed by the one or more processors, cause the electronic device to display, in a task bar area of the display, a row of a first set of objects indicating a plurality of applications executable by the electronic device, detect, through the communication circuit, an external electronic device in proximity to the electronic device, based on detecting the external electronic device, connect with the external electronic device through communication, identify an application which is executable by the external electronic device, display, in the task bar area of the display, a second object indicating the application which is executable by the external electronic device, receive an input relating to the second object, and based on the input, transmit information related to the application corresponding to the second object to the external electronic device through the communication circuit.

### CROSS-REFERENCE TO RELATED APPLICATION(S)

This application is a continuation application, claiming priority under § 365 (c), of an International application No. PCT/KR2024/007829, filed on Jun. 7, 2024, which is based on and claims the benefit of a Korean patent application number 10-2023-0073107, filed on Jun. 7, 2023, in the Korean Intellectual Property Office, and of a Korean patent application number 10-2023-0104065, filed on Aug. 9, 2023, in the Korean Intellectual Property Office, the disclosure of each of which is incorporated by reference herein in its entirety.

### TECHNICAL FIELD

The disclosure relates to an electronic device and a method of controlling an external electronic device using the same.

### BACKGROUND ART

With the development of digital technologies, various types of electronic devices, such as mobile communication terminals, personal digital assistants (PDAs), electronic organizers, smart phones, tablet personal computers (PCs), wearable devices, and/or laptop PCs have become widely used. A hardware part and/or a software part of the electronic device are continuously developed to support and expand functions.

Meanwhile, various applications may be executed to use one or more electronic devices. For example, a user may wiredly or wirelessly connect two electronic devices and execute an application executed in the electronic device through the other electronic device.

The information may be provided as the related art to help understanding of the disclosure. Any opinion or decision on whether the above-mentioned content can be applied as the prior art related to the disclosure has been not provided.

The above information is presented as background information only to assist with an understanding of the disclosure. No determination has been made, and no assertion is made, as to whether any of the above might be applicable as prior art with regard to the disclosure.

### DISCLOSURE OF INVENTION

### Technical Problem

However, a user may find it cumbersome to control another electronic device in order to control functions of an application to be executed by the other electronic device while using an electronic device.

The electronic device according to an embodiment of the disclosure may transmit attribute information related to the application being executed to the other electronic device so that the other electronic device having a communication connection through the application being executed in the electronic device can be executed in the other electronic device. Further, the electronic device according to an embodiment of the disclosure may display at least one object for controlling functions of the application transmitted to the other electronic device on the display.

Aspects of the disclosure are to address at least the above-mentioned problems and/or disadvantages and to provide at least the advantages described below. Accordingly, an aspect of the disclosure is to provide an electronic device and a method of controlling an external electronic device using the same.

Additional aspects will be set forth in part in the description which follows and, in part, will be apparent from the description, or may be learned by practice of the presented embodiments.

### Solution to Problem

In accordance with an aspect of the disclosure, an electronic device is provided. The electronic device includes a communication circuit, memory storing one or more computer programs, a display, and one or more processors communicatively coupled to the communication circuit, the display, and the memory, wherein the one or more computer programs include computer-executable instructions that, when executed by the one or more processors, cause the electronic device to display, in a task bar area of the display, a row of a first set of objects indicating a plurality of applications executable by the electronic device, detect, through the communication circuit, an external electronic device in proximity to the electronic device, based on detecting the external electronic device, connect with the external electronic device through communication, identify an application which is executable by the external electronic device, display, in the task bar area of the display, a second object indicating the application which is executable by the external electronic device, receive an input relating to the second object, and based on the input, transmit information related to the application corresponding to the second object to the external electronic device through the communication circuit.

In accordance with another aspect of the disclosure, a method of controlling an external electronic device by an electronic device is provided. The method includes displaying, in a task bar area of a display, a row of a first set of objects indicating a plurality of applications which is executable by the electronic device, detecting, through a communication circuit, the external electronic device in proximity to the electronic device, based on detecting the external electronic device, connecting with the external electronic device through communication, identifying an application which is executable by the external electronic device, displaying, in the task bar area of a display, a second object indicating the application which is executable by the external electronic device, receiving an input for the second object, and based on the input, transmitting information related to the application corresponding to the second object to the external electronic device through the communication circuit.

In accordance with another aspect of the disclosure, one or more non-transitory computer-readable recording media storing computer-executable instructions that, when executed by one or more processors of an electronic device, cause the electronic device to perform operations are provided. The operations include displaying, in a task bar area of a display, a row of a first set of objects indicating a plurality of applications executable by the electronic device, detecting, through a communication circuit, an external electronic device in proximity to the electronic device, based on detecting the external electronic device, connecting with the external electronic device through communication, identifying an application which is executable by the external electronic device, displaying, in the task bar area of a display, a second object indicating the application which is executable by the external electronic device, receiving an input for the second object, and based on the input, transmitting information related to the application corresponding to the second object to the external electronic device through the communication circuit.

### Advantageous Effects of Invention

An electronic device according to an embodiment of the disclosure can display at least one object for controlling functions of an application transmitted to another electronic device on a display, thereby intuitively controlling the functions of the application being executed in the other electronic device.

An electronic device according to an embodiment of the disclosure displays, at least one object for controlling functions of an application transmitted to another electronic device on a display, thereby preventing cumbersomeness of controlling the other electronic device to control the functions of the application being executed in the other electronic device while using the electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a block diagram of an electronic device within a network environment according to an embodiment of the disclosure;

FIG. 2 is a block diagram illustrating an electronic device according to an embodiment of the disclosure;

FIG. 3A is a flowchart illustrating a method by which an electronic device controls an external electronic device according to an embodiment of the disclosure;

FIG. 3B is a flowchart illustrating a method by which an electronic device controls an external electronic device according to an embodiment of the disclosure;

FIG. 3C is a flowchart illustrating a method by which the electronic device controls an external electronic device according to an embodiment of the disclosure;

FIG. 4 illustrates a flow of signals between an electronic device and an external electronic device according to an embodiment of the disclosure;

FIGS. 5A, 5B, 5C, and 5D are diagrams illustrating a method by which an electronic device controls an external electronic device according to various embodiments of the disclosure;

FIG. 6A is a diagram illustrating a method of displaying at least one object indicating at least one scanned external electronic device according to an embodiment of the disclosure;

FIG. 6B is a diagram illustrating a method of displaying at least one object indicating at least one scanned external electronic device according to an embodiment of the disclosure;

FIGS. 7A and 7B are flowcharts illustrating a method by which an electronic device controls an external electronic device according to various embodiments of the disclosure;

FIG. 8 is a diagram illustrating a method by which an electronic device controls an external electronic device according to an embodiment of the disclosure;

FIGS. 9A, 9B, 9C, and 9D are diagrams illustrating a method by which an electronic device controls an external electronic device according to various embodiments of the disclosure;

FIG. 10 illustrates a flow of signals between an electronic device and an external electronic device according to an embodiment of the disclosure;

FIGS. 11A and 11B are diagrams illustrating a method by which an electronic device controls a plurality of external electronic devices according to various embodiments of the disclosure;

FIGS. 12A, 12B, and 12C are diagrams illustrating a method by which an electronic device controls a plurality of external electronic devices according to various embodiments of the disclosure;

FIGS. 13A and 13B are diagrams illustrating a method of displaying at least one object indicating at least one application and at least one item for controlling at least one function of the at least one application according to various embodiments of the disclosure;

FIG. 14A is a diagram illustrating a navigation area displayed in a task bar area according to an embodiment of the disclosure;

FIG. 14B illustrates common controller items according to an embodiment of the disclosure;

FIG. 15 illustrates a flow of signals between an electronic device, a server, and an external electronic device according to an embodiment of the disclosure;

FIGS. 16A, 16B, 16C, and 16D are diagrams illustrating a method by which an electronic device controls an external electronic device according to various embodiments of the disclosure;

FIG. 17 illustrates a flow of signals between an electronic device, a server, and an external electronic device according to an embodiment of the disclosure; and

FIGS. 18A, 18B, and 18C are diagrams illustrating a method by which an electronic device controls an external electronic device according to various embodiments of the disclosure.

The same reference numerals are used to represent the same elements throughout the drawings.

### MODE FOR THE INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

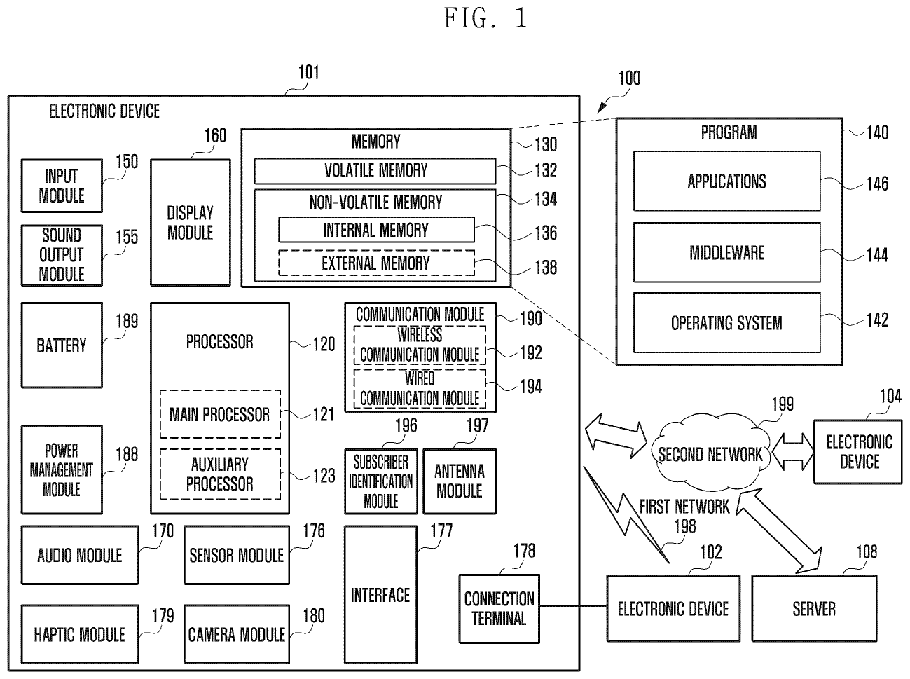

FIG. 1 is a block diagram illustrating an electronic device in a network environment according to an embodiment of the disclosure.

Referring to FIG. 1, an electronic device 101 in a network environment 100 may communicate with an external electronic device 102 via a first network 198 (e.g., a short-range wireless communication network), or at least one of an external electronic device 104 or a server 108 via a second network 199 (e.g., a long-range wireless communication network). According to an embodiment of the disclosure, the electronic device 101 may communicate with the external electronic device 104 via the server 108. According to an embodiment of the disclosure, the electronic device 101 may include a processor 120, memory 130, an input module 150, a sound output module 155, a display module 160, an audio module 170, a sensor module 176, an interface 177, a connection terminal 178, a haptic module 179, a camera module 180, a power management module 188, a battery 189, a communication module 190, a subscriber identification module (SIM) 196, or an antenna module 197. In some embodiments of the disclosure, at least one of the components (e.g., the connection terminal 178) may be omitted from the electronic device 101, or one or more other components may be added in the electronic device 101. In some embodiments of the disclosure, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment of the disclosure, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment of the disclosure, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., a sleep) state, or together with the main processor 121 while the main processor 121 is in an active state (e.g., executing an application). According to an embodiment of the disclosure, the auxiliary processor 123 (e.g., an image signal processor or a communication processor) may be implemented as part of another component (e.g., the camera module 180 or the communication module 190) functionally related to the auxiliary processor 123. According to an embodiment of the disclosure, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory 134 may include internal memory 136 and/or external memory 138.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment of the disclosure, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment of the disclosure, the display module 160 may include a touch sensor adapted to detect a touch, or a pressure sensor adapted to measure the intensity of force incurred by the touch.

The audio module 170 may convert a sound into an electrical signal and vice versa. According to an embodiment of the disclosure, the audio module 170 may obtain the sound via the input module 150, or output the sound via the sound output module 155 or a headphone of an external electronic device (e.g., the external electronic device 102) (e.g., speaker or headphone) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment of the disclosure, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the external electronic device 102) directly (e.g., through wires) or wirelessly. According to an embodiment of the disclosure, the interface 177 may include, for example, a high-definition multimedia interface (HDMI), a universal serial bus (USB) interface, a secure digital (SD) card interface, or an audio interface.

The connection terminal 178 may include a connector via which the electronic device 101 may be physically connected with the external electronic device (e.g., the external electronic device 102). According to an embodiment of the disclosure, the connection terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment of the disclosure, the haptic module 179 may include, for example, a motor, a piezoelectric element, or an electric stimulator.

The camera module 180 may capture a still image or moving images. According to an embodiment of the disclosure, the camera module 180 may include one or more lenses, image sensors, image signal processors, or flashes.

The power management module 188 may manage power supplied to the electronic device 101. According to one embodiment of the disclosure, the power management module 188 may be implemented as at least part of, for example, a power management integrated circuit (PMIC).

The battery 189 may supply power to at least one component of the electronic device 101. According to an embodiment of the disclosure, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the external electronic device 102, the external electronic device 104, or the server 108) and performing communication via the established communication channel. The communication module 190 may include one or more communication processors that are operable independently from the processor 120 (e.g., an application processor (AP)) and supports a direct (e.g., wired) communication or a wireless communication. According to an embodiment of the disclosure, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, Wi-Fi direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN))). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large-scale antenna. The wireless communication module 192 may support various requirements specified in the electronic device 101, an external electronic device (e.g., the external electronic device 104), or a network system (e.g., the second network 199). According to an embodiment of the disclosure, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment of the disclosure, the antenna module 197 may include an antenna including a radiating element including a conductive material or a conductive pattern formed in or on a substrate (e.g., a printed circuit board (PCB)). According to an embodiment of the disclosure, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment of the disclosure, another component (e.g., a radio frequency integrated circuit (RFIC)) other than the radiating element may be additionally formed as part of the antenna module 197.

According to various embodiments of the disclosure, the antenna module 197 may form mmWave antenna module. According to an embodiment of the disclosure, the mmWave antenna module may include a printed circuit board, an RFIC disposed on a first surface (e.g., the bottom surface) of the printed circuit board, or adjacent to the first surface and capable of supporting a designated high-frequency band (e.g., an mmwave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment of the disclosure, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment of the disclosure, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment of the disclosure, the external electronic device 104 may include an internet-of-things (IoT) device. The server 108 may be an intelligent server using machine learning and/or a neural network. According to an embodiment of the disclosure, the external electronic device 104 or the server 108 may be included in the second network 199. The electronic device 101 may be applied to intelligent services (e.g., smart home, smart city, smart car, or healthcare) based on 5G communication technology or IoT-related technology.

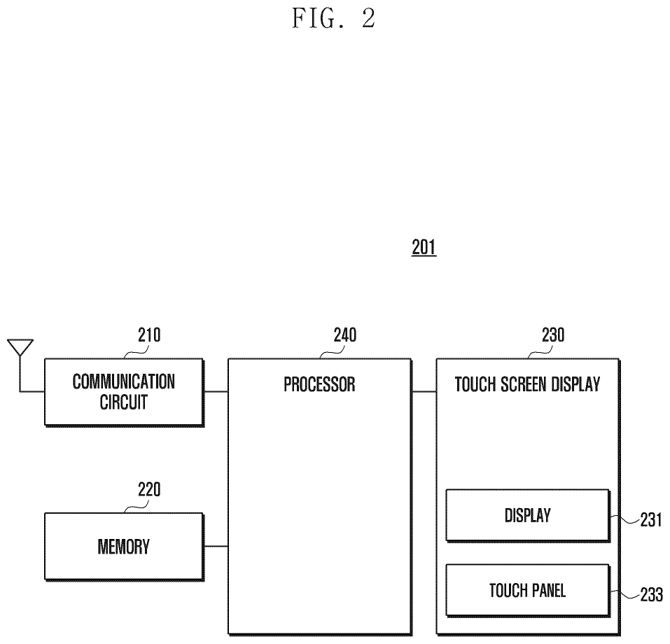

FIG. 2 is a block diagram of an electronic device according to an embodiment of the disclosure.

Referring to FIG. 2, an electronic device 201 (for example, the electronic device 101 of FIG. 1) may include a communication circuit 210 (for example, the communication module 190 of FIG. 1), memory 220 (for example, the memory 130 of FIG. 1), a touch screen display 230 (for example, the display module 160 of FIG. 1), and/or a processor 240 (for example, the processor 120 of FIG. 1).

According to an embodiment of the disclosure, the communication circuit 210 (for example, the communication module 190 of FIG. 1) may establish a communication channel with an external electronic device (for example, the external electronic device 102 of FIG. 1) and support transmission and reception of various pieces of data to and from the external electronic device. For example, the communication circuit 210 may establish a wireless communication channel with the external electronic device and support performance of communication through the established communication channel. The communication circuit 210 may support short-range wireless communication, such as ultra-wideband (UWB), Bluetooth, and Bluetooth low energy. However, the disclosure is not limited thereto.

According to an embodiment of the disclosure, the memory 220 (for example, the memory 130 of FIG. 1) may perform a function of storing a program (for example, the program 140 of FIG. 1) for processing and controlling the processor 240 of the electronic device 201, an operating system (OS) (for example, the operation system 142 of FIG. 1), various applications, and/or input/output data and store a program for controlling the overall operation of the electronic device 201. The memory 220 may store various instructions that can be executed by the processor 240.

According to an embodiment of the disclosure, through a task bar area (for example, at least a partial area of the touch screen display 230), the memory 220 may store instructions for displaying at least one first object indicating at least one scanned (or found) external electronic device located close to the electronic device 201, at least one second object indicating at least one application which can be executed in an external electronic device, and/or at least one item for controlling at least one function of an application according to the control of the processor 240.

According to an embodiment of the disclosure, the touch screen display 230 (for example, the display module 160 of FIG. 1) may be implemented in an integrated form including the display 231 and a touch panel 233 and may display an image according to the control of the processor 240.

In an embodiment of the disclosure, the display 231 may be implemented as one of a liquid crystal display (LCD), a light-emitting diode (LED) display, a micro-LED (μLED) display, an organic light-emitting diode (OLED) display, an active matrix organic light-emitting diode (AMOLED) display, a micro electro mechanical systems (MEMS) display, an electronic paper display, a flexible display, or a rollable display. However, the disclosure is not limited thereto.

In an embodiment of the disclosure, the touch panel 233 may be a complex touch panel including a hand touch panel for detecting a hand gesture and a pen touch panel for detecting a pen gesture.

In an embodiment of the disclosure, the touch screen display 230 may display at least one first object indicating at least one scanned (or found) external electronic device located close to the electronic device 201, at least one second object indicating at least one application which can be executed in an external electronic device, and/or at least one item for controlling at least one function of an application through a task bar area (for example, at least a partial area of the touch screen display 230) according to the control of the processor 240.

In an embodiment of the disclosure, the touch screen display 230 may display information related to an application (for example, screen) according to the control of the processor 240.

According to an embodiment of the disclosure, the processor 240 (for example, the processor 120 of FIG. 1) may include, for example, a micro controller unit (MCU), and may run an operating system (OS) or an embedded software program to control a plurality of hardware components connected to the processor 240. The processor 240 may control a plurality of hardware components according to, for example, instructions (for example, the program 140 of FIG. 1) stored in the memory 220.

In an embodiment of the disclosure, the processor 240 may display a row of a first set of objects indicating a plurality of applications which can be executed by the electronic device 201 in a task bar area of the display 231. For example, first objects indicting a plurality of applications which can be executed by the electronic device 201 may include at least one object indicating at least one application being executed in the electronic device 201 (for example, at least one application being displayed on the display 231 and/or at least one application being executed in the background), an object indicating an application which is most frequently executed in the electronic device 201, at least one object indicating at least one application which has been executed in the electronic device 201 more than a predetermined number of times, and/or at least one object indicating at least one application configured as application frequently used by the user of the electronic device 201.

In an embodiment of the disclosure, the processor 240 may detect an external electronic device in proximity to the electronic device 201 through the communication circuit 210. For example, the processor 240 may detect an external electronic device in proximity to the electronic device 201 through short-range wireless communication, such as UWB, Bluetooth, or Bluetooth low energy. The processor 240 may be connected with the external electronic device through communication, based on that proximity of the external electronic device is detected. The processor 240 may identify an application which can be executed in the external electronic device, based on the communication connection is made with the external electronic device, and display a second object indicating the application in a task bar area of the display 231. In an embodiment of the disclosure, the second object indicating the application which can be executed in the external electronic device may include at least one object indicating at least one application being executed in the electronic device 201 (for example, at least one application being displayed on the display 231 and/or at least one application being executed in the background), an object indicating an application which is most frequently executed in the electronic device 201, at least one object indicating at least one application which has been executed in the electronic device 201 more than a predetermined number of times, and/or at least one object indicating at least one application configured as application frequently used by the user of the electronic device 201. However, the disclosure is not limited thereto, and the second object indicating the application which can be executed in the external electronic device may include at least one object indicating at least one application which has been executed in the external electronic device more than a predetermined number of times and/or an object indicating an application which has been most frequently executed in the external electronic device.

In an embodiment of the disclosure, when receiving an input for the second object, the processor 240 may transmit information related to the application corresponding to the second object to the external electronic device through the communication circuit 210. For example, the information related to the application corresponding to the second object may include identification information for identifying the application, login information (for example, account information) of the application, and/or information related to execution of the application. However, the disclosure is not limited thereto.

In an embodiment of the disclosure, after transmitting the information related to the application corresponding to the second object to the external electronic device, the processor 240 may display at least one item for controlling at least one function of the application to be adjacent to the second object. When an input for selecting one of the at least one item is detected, the processor 240 may transmit a signal making a request for performing a function corresponding to the selected item to the external electronic device.

In an embodiment of the disclosure, the processor 240 may display information related to an application being output by the external electronic device in at least a partial area of the display 231, based on that a first user input is detected. When the first user input is detected, the processor 240 may display, through a popup window, the information related to the application being output by the external electronic device to be adjacent to at least one item for which the first user input has been detected. The processor 240 may enter a multi-window arrangement mode, based on that a second user input is detected. The processor 240 may receive information related to the application from the external electronic device, based on that a third user input for moving from a popup window for the information related to the application being output by an external electronic device 401 to a specific area of the display 231 is detected. The processor 240 may output the information related to the application, based on the information related to the application received from the external electronic device 401. For example, the processor 240 may output visual information of the application (for example, screen) to the display 231 and/or output auditory information of the application (for example, audio signal) through an audio output circuit.

In an embodiment of the disclosure, the processor 240 may display at least one object indicating at least one application which can be executed in the external electronic device 401 in the task bar area of the display 231. In an embodiment of the disclosure, the processor 240 may transmit attribute information related to a specific application to the external electronic device, based on that a fourth user input of moving from a screen of the specific application being displayed on the display 231 to the popup window for the information related to the application being output by external electronic device.

The electronic device 201 according to an embodiment of the disclosure may include the communication circuit 210, the display 231, the memory 220 storing instructions, and the processor 240. The instructions that, when executed by the processor 240, cause the electronic device 201 to display a row of a first set of objects indicating a plurality of applications executable by the electronic device 201 in the task bar area 520 of the display 231. The instructions that, when executed by the processor 240, cause the electronic device 201 to detect the external electronic device 401 in proximity to the electronic device 201 through the communication circuit 210. The instructions that, when executed by the processor 240, cause the electronic device 201 to connect with the external electronic device 401 through communication, based on detecting the external electronic device 401. The instructions that, when executed by the processor 240, cause the electronic device 201 to identify an application which can be executed by the external electronic device 401. The instructions that, when executed by the processor 240, cause the electronic device 201 to display a second object indicating the application which is executable by the external electronic device 401 in the task bar area 520 of the display 231. The instructions that, when executed by the processor 240, cause the electronic device 201 to receive an input for the second object. The instructions that, when executed by the processor 240, cause the electronic device 201 to transmit information related to the application corresponding to the second object to the external electronic device 401 through the communication circuit 210, based on the input for the second object.

The instructions that, when executed by the processor 240, cause the electronic device 201 to display an execution screen of a second application on the display 231. The instructions that, when executed by the processor 240, cause the electronic device 201 to display a home button while displaying the row of the first set of the objects and the second object in the task bar area 520.

The task bar area 520 according to an embodiment may be located between the execution screen of the second application and a bottom edge of the display 231.

The instructions that, when executed by the processor 240, cause the electronic device 201 to display at least one item for controlling at least one function of the application to be adjacent to the second object.

The instructions that, when executed by the processor 240, cause the electronic device 201 to, in case that the second object indicates a multi-media player application, display user interface items for controlling functions of the multi-media player application to be adjacent to the second object.

The instructions that, when executed by the processor 240, cause the electronic device 201 to identify a plurality of applications which is executable on the external electronic device 401. The instructions that, when executed by the processor 240, cause the electronic device 201 to select a subset of the plurality of applications which are executable on the external electronic device 401, based on a predefined condition. The instructions that, when executed by the processor 240, cause the electronic device 201 to display a row of second objects indicating the selected subset of the plurality of applications which are executable on the external electronic device 401 in the task bar area 520 of the display 231.

The predefined condition for selecting the subset of the plurality of applications may include a type of information to be output by the external electronic device 401 according to a type of the external electronic device 401.

The instructions that, when executed by the processor 240, cause the electronic device 201 to identify whether a first user input is detected on at least one item displayed in the task bar area 520 of the display 231. The instructions that, when executed by the processor 240, cause the electronic device 201 to, in case that the first user input is detected, display information related to the application being output from the external electronic device 401 on the display 231 in a popup form. The instructions that, when executed by the processor 240, cause the electronic device 201 to identify whether a second user input is detected on the information displayed in the popup form and related to the application being output from the external electronic device 401. The instructions that, when executed by the processor 240, cause the electronic device 201 to, in case that the second user input is detected, enter a multi-window arrangement mode.

The instructions that, when executed by the processor 240, cause the electronic device 201 to identify whether a third user input is detected on the information displayed in the popup form and related to the application being output from the external electronic device 401 after entering the multi-window arrangement mode. The instructions that, when executed by the processor 240, cause the electronic device 201 to, in case that the third user input is detected, transmit a signal for requesting transmission of the information related to the application being output in the external electronic device 401 to the external electronic device 401. The instructions that, when executed by the processor 240, cause the electronic device 201 to receive the information related to the application being output in the external electronic device 401 from the external electronic device 401 through the communication circuit 210 in response to the signal for requesting the transmission. The instructions that, when executed by the processor 240, cause the electronic device 201 to output the information related to the application, based on the received information related to the application being output in the external electronic device 401.

The instructions that, when executed by the processor 240, cause the electronic device 201 to identify whether a fourth user input is detected in the execution screen of the second application being displayed on the display 231 after entering the multi-window arrangement mode. The instructions that, when executed by the processor 240, cause the electronic device 201 to, in case that the fourth user input is detected, transmit the information related to the second application to the external electronic device 401 through the communication circuit 210. The instructions that, when executed by the processor 240, cause the electronic device 201 to display the object indicating the second application and at least one item for controlling at least one function related to the second application in the task bar area 520 of the display 231.

The instructions that, when executed by the processor 240, cause the electronic device 201 to, in case that the fourth user input is detected, identify whether the second application is an application supported by the external electronic device 401. The instructions that, when executed by the processor 240, cause the electronic device 201 to, in case that the second application is identified as the application supported by the external electronic device 401, apply a first visual effect to the information related to the application being output by the external electronic device 401 displayed in the popup form and display the information. The instructions that, when executed by the processor 240, cause the electronic device 201 to, in case that the second application is identified as an application which is not supported by the external electronic device 401, apply a second visual effect to the information related to the application being output by the external electronic device 401 displayed in the popup form and display the information.

The electronic device 201 according to an embodiment of the disclosure may include the communication circuit 210, the display 231, the processor 240 operatively connected to the communication circuit 210 and the display 231, and the memory 220 operatively connected to the processor 240. The instructions that, when executed by the processor 240, cause the electronic device 201 to display an execution screen of an application. The instructions that, when executed by the processor 240, cause the electronic device 201 to display a home button for moving to a home screen in the task bar area 520 located between the execution screen and a bottom edge of the display 231. The instructions that, when executed by the processor 240, cause the electronic device 201 to display a row of a first set of objects indicating a plurality of applications which can be executed by the electronic device 201 in the task bar area 520 of the display 231. The instructions that, when executed by the processor 240, cause the electronic device 201 to detect the external electronic device 401 in proximity to the electronic device 201 through the communication circuit 210. The instructions that, when executed by the processor 240, cause the electronic device 201 to make a connection with the external electronic device 401 through communication, based on that the external electronic device 401 is detected. The instructions that, when executed by the processor 240, cause the electronic device 201 to identify an application which can be executed by the external electronic device 401. The instructions that, when executed by the processor 240, cause the electronic device 201 to display a second object indicating the application which can be executed by the external electronic device 401 in the task bar area 520 of the display 231. The instructions that, when executed by the processor 240, cause the electronic device 201 to receive an input for the second object. The instructions that, when executed by the processor 240, cause the electronic device 201 to transmit information related to the application corresponding to the second object to the external electronic device 401 through the communication circuit 210, based on the input.

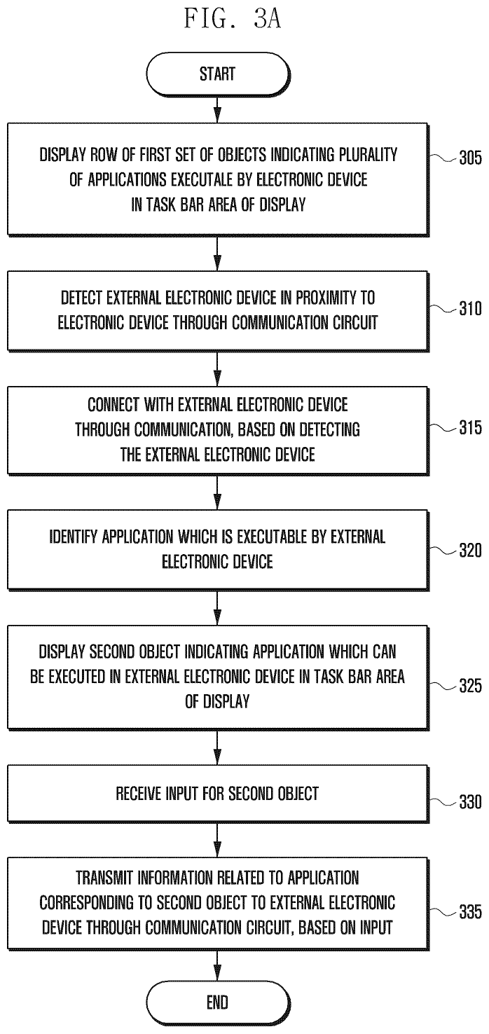

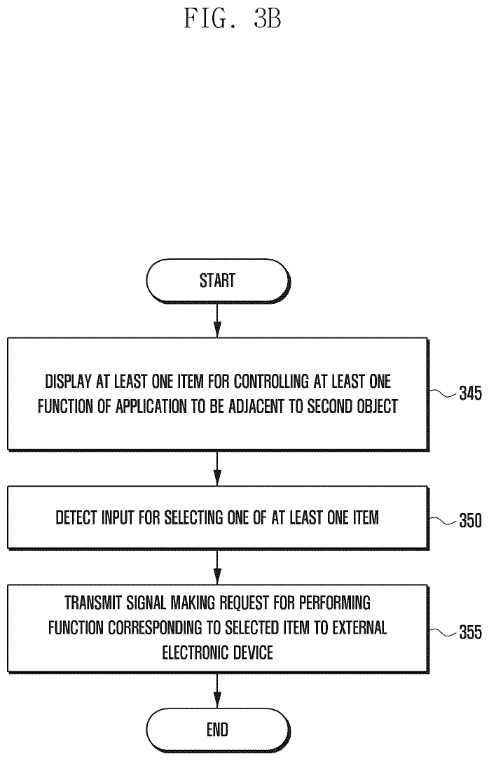

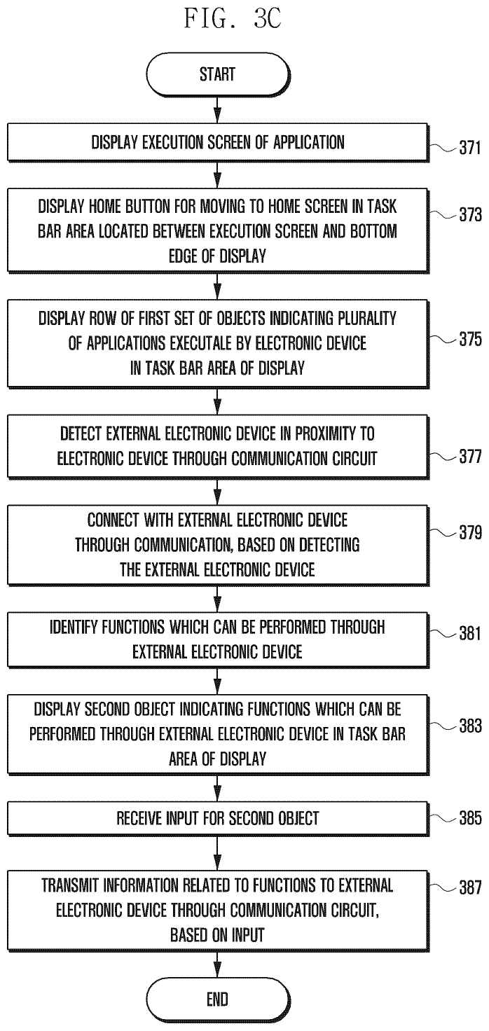

FIG. 3A is a flowchart illustrating a method by which an electronic device controls an external electronic device according to an embodiment of the disclosure.

In the following embodiments of the disclosure, respective operations may be sequentially performed but the sequential performance is not necessary. For example, orders of the operations may be changed, and at least two operations may be performed in parallel.

According to an embodiment of the disclosure, operation 305 to operation 335 may be understood as being performed by a processor (for example, the processor 240 of FIG. 2) of an electronic device (for example, the electronic device 201 of FIG. 2).

Referring to FIG. 3A, the processor 240 may display a row of a first set of objects indicating a plurality of applications executable by the electronic device 201 in a task bar area of a display (for example, the display 231 of FIG. 2) in operation 305.

In an embodiment of the disclosure, the objects indicating the plurality of applications which executable by the electronic device 201 may include at least one object indicating at least one application being executed in the electronic device 201 (for example, at least one application being displayed on the display 231 and/or at least one application being executed in the background), an object indicating an application which is most frequently executed in the electronic device 201, at least one object indicating at least one application which has been executed in the electronic device 201 more than a predetermined number of times, and/or at least one object indicating at least one application configured as application frequently used by the user of the electronic device 201.

In an embodiment of the disclosure, the task bar area may be displayed in at least a partial area of the display 231. For example, the task bar area may be displayed in a lower area of the display 231 of the electronic device 201. In another example, when screens of at least one application are being displayed on the display 231, the task bar area may be located (or displayed) between the screens of the at least one application and a bottom edge of the display 231. However, the disclosure is not limited thereto.

In an embodiment of the disclosure, when a specific input is detected, the task bar area may be displayed in at least a partial area (for example, a lower area) of the display 231. The specific input according to an embodiment may include a swipe input. However, the disclosure is not limited thereto.

In an embodiment of the disclosure, the task bar area may be displayed in at least a partial area of the display 231 in a specific condition. For example, the specific condition according to an embodiment may include a condition of detecting proximity of at least one external electronic device to the electronic device 201 or a condition of making a communication connection with at least one external electronic device, the condition being described below. However, the disclosure is not limited thereto.

In an embodiment of the disclosure, the processor 240 may temporarily display the task bar area in at least a partial area (for example, a lower area) of the display 231. For example, when a predetermined time passes in the state where the task bar area is displayed in at least the partial area (for example, the lower area) of the display 231, displaying the task bar area may end. The disclosure is not limited thereto, and the processor 240 may continuously display the task bar area in at least the partial area (for example, the lower area) of the display 231.

In an embodiment of the disclosure, the processor 240 may detect an external electronic device in proximity to the electronic device 201 through a communication circuit (for example, the communication circuit 210 of FIG. 2) in operation 310. For example, the processor 240 may detect the external electronic device in proximity to the electronic device 201 through predetermined communication (for example, UWB, Bluetooth, or Bluetooth low energy). For example, the processor 240 may identify an external electronic device which can make the communication connection through predetermined communication.

In an embodiment of the disclosure, the user may move the external electronic device which exists at a location outside a predetermined range from the electronic device 201 to a location within the predetermined range from the electronic device 201. In another example, the user may move the electronic device 201 to be adjacent to the external electronic device so that the electronic device 201 and the external electronic device exist within the predetermined range. In this case, the processor 240 may detect (or identify) the external electronic device in proximity to the electronic device 201 (for example, detect the existence within the predetermined range) through predetermined communication.

In an embodiment of the disclosure, the external electronic device may be a device (for example, a wireless audio wearable electronic device in an car wearable type designed to be worn on user's ears, an audio output device (for example, a speaker), a smartphone, a tablet personal computer (PC), a desktop personal computer (PC), a laptop personal computer (PC), or a smart television (TV)) including at least one output module (for example, a display, an audio output circuit, and/or a haptic module).

In an embodiment of the disclosure, when the external electronic device in proximity to the electronic device 201 is detected, the processor 240 may provide a user interface indicating the proximity of the external electronic device.

For example, the processor 240 may automatically activate short-range wireless communication (for example, the first network 198 of FIG. 1) (for example, Bluetooth or Wi-Fi), based on location information (for example, home or office) of the electronic device 201 and, when the external electronic device (for example, the external electronic device capable of making the communication connection) in proximity to the electronic device 201 is detected, provide a user interface indicating proximity of the external electronic device. In another example, the processor 240 may detect proximity of the external electronic device based on Wi-Fi direct. Each of at least two devices existing in the same place (or within a predetermined range) may broadcast a signal indicating that the communication connection is possible through Wi-Fi direct. For example, when it is assumed that devices existing in the same place are the electronic device 201 and the external electronic device, each of the electronic device 201 and the external electronic device may broadcast a signal indicating that the communication connection is possible through Wi-Fi direct. The processor 240 may identify the external electronic device which can make the communication connection, based on the broadcasted signal received from the external electronic device, and provide a user interface indicating proximity of the external electronic device. In another example, when the external electronic device in proximity to the electronic device 201 is detected through Bluetooth scan at predetermined time intervals (for example, about 3 minutes or about 5 minutes), the processor 240 may provide a user interface indicating proximity of the external electronic device.

The external electronic device in proximity to the electronic device 201 may broadcast a signal including information on the external electronic device (for example, login information, identification information (for example, a device name), a device type, and a medium access control (MAC) address) through the above-described method. The processor 240 may perform the scan for a predetermined time (or at predetermined time intervals) to receive the signal broadcasted by the external electronic device. The processor 240 may compare information on the external electronic device included in the received broadcasting signal with information on the external electronic device stored in the memory (for example, the memory 220 of FIG. 2) and make the communication connection with the external electronic device, based on at least some matching information.

In an embodiment of the disclosure, the processor 240 may display an object indicating the external electronic device located in proximity to the electronic device 201 in the task bar area of the display 231.

In an embodiment of the disclosure, the processor 240 may provide a notification indicating that the external electronic device in proximity to the electronic device 201 is detected through a tactile signal (for example, vibration) and/or an auditory signal (for example, an audio signal).

In an embodiment of the disclosure, the external electronic device located in proximity to the electronic device 201 may be a plurality of external electronic devices. In this case, the processor 240 may display a first object indicating a first external electronic device first scanned by a scan operation among the plurality of external electronic devices. The processor 240 may display at least one second object indicating at least one other second external electronic device scanned thereafter such that the at least one second object is listed based on the first object (for example, to the right of the first object). The disclosure is not limited thereto, and the processor 240 may display a plurality of objects indicating a plurality of external electronic devices located in proximity to the electronic device 201 in the task bar area, based on an external electronic device having the communication connection more than a predetermined number to times, an external electronic device having the login with the same account, an external electronic device configured as a device frequency used by the user, or an external electronic device having a stable communication connection state (for example, an external electronic device having a communication signal quality (for example, reference signal received power (RSRP), received signal strength indicator (RSSI), reference signal received quality (RSRQ), and/or signal to noise ratio (SNR)) satisfying a reference value) among the plurality of external electronic devices.

In an embodiment of the disclosure, when a specific user input (for example, a long press input) is detected on a specific object among the plurality of objects indicating the plurality of external electronic devices displayed in the task bar area, the processor 240 may configure the external electronic device corresponding to the specific object as a frequently used external electronic device or as an external electronic device to be not displayed in the task bar area even though the external electronic device has been scanned.

In an embodiment of the disclosure, an operation of scanning the external electronic device in proximity to the electronic device 201 may be performed for a predetermined time (for example, about 30 seconds) at a predetermined interval (for example, about 5 seconds). The disclosure is not limited thereto, and the first object for performing the operation of scanning the external electronic device may be provided. In this case, when an input for selecting the first object is detected, the processor 240 may perform the operation of scanning the external electronic device or may stop the operation of scanning the external electronic device.

In an embodiment of the disclosure, when the number of a plurality of scanned external electronic devices is larger than a predetermined number and thus a plurality of objects indicating the plurality of scanned external electronic devices cannot be displayed in the task bar area, the processor 240 may display a second object (for example, a scroll object or a show more menu) in the task bar area. When an input of selecting the second object is detected, the processor 240 may display at least one object indicating at least one external electronic device which has been scanned but has not been displayed in the task bar area in the task bar area or may display the same to be in proximity to the second object in a list form.

In an embodiment of the disclosure, the plurality of objects indicating the plurality of scanned external electronic devices may be displayed differently depending on types of the external electronic devices. For example, the types of the external electronic devices may include a TV, a watch, a smartphone, a tablet PC, a desktop PC, a laptop PC, a wireless audio output device (for example, a Bluetooth speaker), and a wireless audio wearable electronic device (for example, Bluetooth earphones). The disclosure is not limited thereto, and the types of the external electronic devices may also include an external electronic device having a display and an audio output circuit and an external electronic device having only an audio output circuit without a display.

In an embodiment of the disclosure, the processor 240 may display guide information indicating a type of information which can be output based on the types of the plurality of external electronic devices. For example, when the external electronic device can output visual information and auditory information, the processor 240 may output guide information indicating that the corresponding external electronic device is able to output visual information and auditory information. In another example, when the external electronic device can output only the auditory information, the processor 240 may output guide information indicating that the corresponding external electronic device is able to output only the auditory information.

In an embodiment of the disclosure, the processor 240 may provide a user interface through which the user can select the type of information (for example, visual information and/or auditory information) to be output to the external electronic device.

In an embodiment of the disclosure, the processor 240 may be connected to the external electronic device through communication, based on detecting the external electronic device in operation 315. For example, when a distance between the electronic device 201 and the external electronic device becomes a predetermined distance or shorter, the processor 240 may make the communication connection with the external electronic device through communication (for example, short-range wireless communication, such as UWB, Bluetooth, or Bluetooth low energy).

In an embodiment of the disclosure, when there is no history of the communication connection with the external electronic device, the processor 240 may perform an operation of making the initial communication connection with the external electronic device. For example, the processor 240 and the external electronic device may exchange their own information through the operation of making the initial connection. For example, the processor 240 may receive identification information of the external electronic device or information related to an application (for example, information on an application being executed in the external electronic device, information on an application installed in the external electronic device, information on the number of executions of the application in the external electronic device, or information on the time at which the application is executed in the external electronic device) from the external electronic device. The processor 240 may transmit the identification information of the electronic device 201 to the external electronic device.

In an embodiment of the disclosure, the processor 240 may identify an application which is executable by the external electronic device in operation 320.

In an embodiment of the disclosure, the application which is executable by the external electronic device may include at least one application being executed in the electronic device 201 (for example, at least one application being displayed on the display 231 and/or at least one application being executed in the background), an application which is most frequently executed in the electronic device 201, at least one application which has been executed in the electronic device 201 a predetermined number of times or more, and/or at least one application configured as application frequently used by the user of the electronic device 201. However, the disclosure is not limited thereto, and the application which is executable by the external electronic device may also include at least one application which has been executed in the external electronic device a predetermined number of times or more and/or an application which has been most frequently executed in the external electronic device.

In an embodiment of the disclosure, the processor 240 may display the second object indicating the application which is executable in the external electronic device in the task bar area of the display 231 in operation 325. For example, instead of displaying the object indicating an external electronic device located in proximity to the electronic device in the task bar area, based on that the communication connection with the external electronic device is made, the processor 240 may display at least one object indicating at least one application which is executable in the external electronic device. The disclosure is not limited thereto, and the processor 240 may display, in the task bar area, at least one object indicating at least one application which is executable in the external electronic device located in proximity to the electronic device along with the object indicating the external electronic device located in proximity to the electronic device 201, based on that the communication connection with the external electronic device is made.

In an embodiment of the disclosure, the application which is executable in the external electronic device may be displayed based on a type of the external electronic device. For example, when the external electronic device having the communication connection includes a display, the processor 240 may preferentially display an application (for example, an application related to image reproduction) related to multimedia content in the task bar area. In another example, when the external electronic device having the communication connection does not include a display, the processor 240 may preferentially display an application (for example, a music application) related to output of an audio signal in the task bar area.

The disclosure is not limited thereto, and the processor 240 may preferentially display a most frequently executed application, an application which has been executed a predetermined number of times or more, or an application configured as an application frequently used by the user in the task bar area. Alternatively, in the case where a specific application is configured to be automatically executed in the external electronic device when the communication connection with the external electronic device is made, the processor 240 may not display at least one object indicating at least one application in the task bar area.

In an embodiment of the disclosure, the processor 240 may receive an input for the second object in operation 330. For example, the input for the second object may include an input of selecting the second object. However, the disclosure is not limited thereto.

In an embodiment of the disclosure, the processor 240 may transmit information related to an application corresponding to the second object to the external electronic device through the communication circuit 210, based on an input in operation 335.

In an embodiment of the disclosure, the information related to the application corresponding to the second object may include identification information for identifying the application, login information (for example, account information) of the application, and/or information related to execution of the application. For example, when the application is an application related to multimedia content, the information related to execution of the application may include information on the reproduction time of the multimedia content. When the application is a browser application, the information related to execution of the application may be link information.

In an embodiment of the disclosure, the processor 240 may transmit the information related to the application corresponding to the second object to the external electronic device, based on the type of the external electronic device. For example, the processor 240 may transmit information on a type of selected information to the external electronic device through a user interface for selecting the type (for example, visual information and/or auditory information) of information to be output to the external electronic device. In another example, when it is identified that the type of the external electronic device is an external electronic device including a display and an audio output circuit, the processor 240 may transmit information on visual information and audio information to the external electronic device. In another example, when it is identified that the type of the external electronic device is an external electronic device including only the audio output circuit without the display, the processor 240 may transmit only the information on the auditory information to the external electronic device.

It has been described that the information related to the application corresponding to the second object is transmitted to the external electronic device, based on the input in operation 335 according to various embodiments of the disclosure, the disclosure is not limited thereto. For example, the processor 240 may transmit application information corresponding to an application which has been executed a predetermined number of timer or more, a recently executed application, a multi-media application, an application having a large window size, based on a communication connection with an external electronic device when screens of a plurality of applications are displayed on the display 231 in a multi-window form, or an application related to an input interface (for example, a keypad or a keyboard displayed on the display 231 in software) to the external electronic device.

In an embodiment of the disclosure, although not illustrated, when the input for the second object is not received, the processor 240 may display an indicator indicating that the input for the second object has not been received in the task bar area or an indicator for inducing the input for the second object in the task bar area after a predetermined time passes.

Referring to FIG. 3A, it has been described that the information related to the application corresponding to the second object is transmitted to the external electronic device according to the type of the external electronic device, based on that the input for the second object is received, but the disclosure is not limited. For example, the processor 240 may display an object indicating the electronic device 201 in the task bar area. When an input of selecting the object indicating the electronic device 201 displayed in the task bar area is detected, the processor 240 may perform a mirroring function. For example, the processor 240 may transmit information related to at least one application being executed in the electronic device 201 to the external electronic device. For example, the information related to at least one application may include display information (for example, information on the size of the screen of the application) and/or audio information.

In various embodiments of the disclosure, although not illustrated, when the communication connection with the external electronic device is made and it is identified that a specific application is being executed in the external electronic device, the processor 240 may omit operation 320 to operation 335. For example, when it is identified that the external electronic device having the communication connection is executing the specific application, the processor 240 may display an object indicating the specific application being executed in the external electronic device and at least one item for controlling at least one function of the specific application in the task bar area.

FIG. 3B is a flowchart illustrating a method by which an electronic device controls an external electronic device according to an embodiment of the disclosure.

In the following embodiments of the disclosure, respective operations may be sequentially performed but the sequential performance is not necessary. For example, orders of the operations may be changed, and at least two operations may be performed in parallel.

According to an embodiment of the disclosure, operation 345 to operation 355 may be understood as being performed by a processor (for example, the processor 240 of FIG. 2) of an electronic device (for example, the electronic device 201 of FIG. 2).

FIG. 3B according to various embodiments may be additional operations of FIG. 3A.

Referring to FIG. 3B, the processor 240 may display at least one item for controlling at least one function of the application to be adjacent to the second object in operation 345.

In an embodiment of the disclosure, at least one function of the application may be different depending on a type of the application. For example, when the application is an application related to multimedia content, at least one function of the application may include a function for controlling reproduction of the multimedia content (for example, pause, play, forward, and/or backward). In another example, when the application is an application related to a user interface, at least one function of the application may include a function for controlling the user interface (for example, forward, backward, and/or home). In another example, when the application is a photo application, at least one function of the application may include a function of displaying a previous photo, a function of displaying a next photo, and/or a function of displaying a recommended photo. However, the disclosure is not limited thereto.

In an embodiment of the disclosure, at least one function of the application may include a function of terminating the application (for example, a function of terminating output of information related to the application by the external electronic device).

In an embodiment of the disclosure, the processor 240 may detect an input of selecting one of at least one item (for example, at least one item for controlling at least one function of the application) in operation 350.

For example, when it is assumed that the application is an application related to multimedia content, at least one item may include an item for pausing the multimedia content, an item for reproducing the multimedia content, an item for reproducing the multimedia content at a time point earlier than the current time point, and/or an item for reproducing the multimedia content at a time point later than the current time point. In another example, when it is assumed that the application is an application related to a user interface, at least one item may include an item for displaying a previous screen, an item for displaying a next screen, and/or an item for displaying a home screen. In another example, when it is assumed that the application is a photo application, at least one item may include an item for displaying a previous photo, an item for displaying a next photo, and/or an item for displaying a recommended photo. However, the disclosure is not limited thereto.

In an embodiment of the disclosure, the processor 240 may transmit a signal making a request for performing the function corresponding to the selected item to the external electronic device in operation 355. For example, when it is assumed that the application is the application related to multimedia content and an input of selecting the item for pausing the multimedia content is detected, the processor 240 may transmit a signal making a request for pausing the multimedia content to the external electronic device. In another example, when the input of selecting the item for reproducing the multimedia content is detected, the processor 240 may transmit a signal making a request for reproducing the multimedia content to the external electronic device. In another example, when an input for selecting the item for reproducing the multimedia content at a time point earlier than the current time point is detected, the processor 240 may transmit a signal making a request for reproducing the multimedia content at the time point earlier than the current time point to the external electronic device. In another example, when an input for selecting the item for reproducing the multimedia content at a time point later than the current time point is detected, a signal making a request for reproducing the multimedia content at the time point later than the current time point may be transmitted to the external electronic device.

FIG. 3C is a flowchart illustrating a method by which an electronic device controls an external electronic device according to an embodiment of the disclosure.

In the following embodiments of the disclosure, respective operations may be sequentially performed but the sequential performance is not necessary. For example, orders of the operations may be changed, and at least two operations may be performed in parallel.

According to an embodiment of the disclosure, operation 371 to operation 387 may be understood as being performed by a processor (for example, the processor 240 of FIG. 2) of an electronic device (for example, the electronic device 201 of FIG. 2).

Since operation 375, operation 377, and operation 379 of FIG. 3C according to various embodiments are the same as operation 305, operation 310, and operation 315 of FIG. 3A described above, detailed description thereof may be replaced with the description of FIG. 3A.

Referring to FIG. 3C, the processor 240 may display an execution screen of the application in operation 371. For example, the processor 240 may display the execution screen of the application on the display (for example, the display 231 of FIG. 2), based on that an input of executing the application is detected. In an embodiment of the disclosure, when a plurality of applications is executed, screens of the plurality of applications may be displayed on the display 231 in a multi-window form.

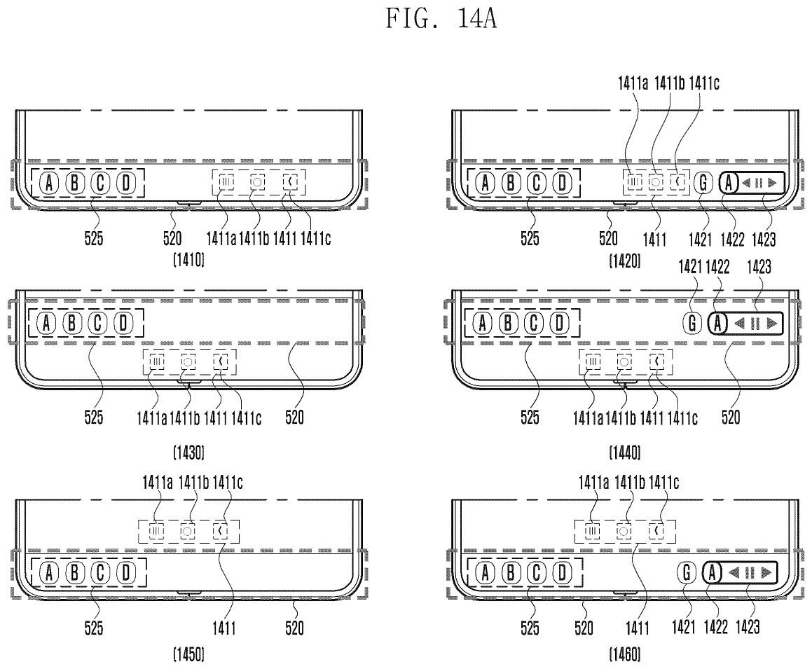

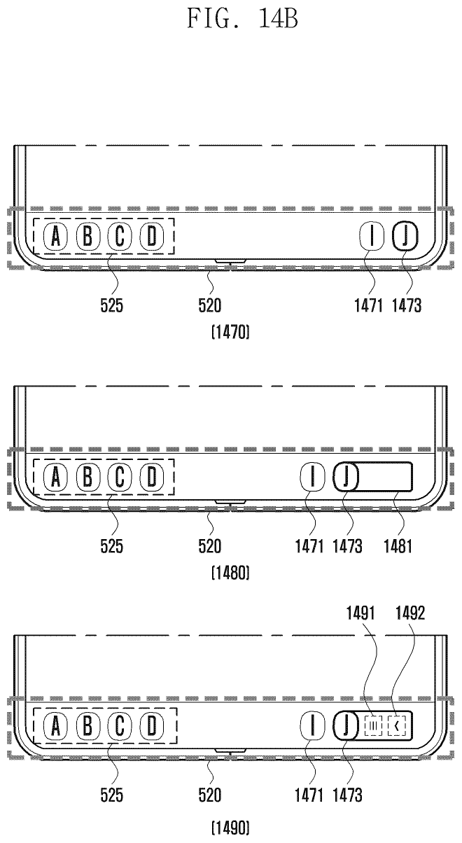

In an embodiment of the disclosure, the processor 240 may display a home button for moving from a task bar area located between the execution screen and a bottom edge of the display 231 to the home screen in operation 373. For example, the processor 240 may display a navigation area (for example, a navigation area 1411 of FIG. 14A) within the task bar area and display a home button for moving to the home screen through the navigation area. The disclosure is not limited thereto, and the navigation area may be displayed in an area adjacent to the task bar area (for example, an upper area of the task bar area or a lower area of the task bar area), and the home button may be displayed through the navigation area.

In an embodiment of the disclosure, the processor 240 may display a row of a first set of objects indicating a plurality of applications executable by the electronic device 201 in the task bar area of the display 231 in operation 375. The processor 240 may detect an external electronic device in proximity to the electronic device 201 through a communication circuit (for example, the communication circuit 210 of FIG. 2) in operation 377. The processor 240 may be connected to the external electronic device through communication, based on detecting the external electronic device in operation 379.

In an embodiment of the disclosure, the processor 240 may identify functions which can be performed through the external electronic device in operation 381. For example, the functions which can be performed through the external electronic device may include a function of executing an application in the external electronic device, a function of controlling functions of an application being executed in the external electronic device, and/or a function of outputting, to the external electronic device, visual information (for example, a screen) and/or auditory information (for example, an audio signal) being output by the electronic device 201.

In an embodiment of the disclosure, the processor 240 may display a second object indicating a function which can be performed through the external electronic device in the task bar area of the display 231 in operation 383. The processor 240 may receive an input for the second object in operation 385. For example, the input for the second object may include an input of selecting the second object. However, the disclosure is not limited thereto. The processor 240 may transmit information related to functions to the external electronic device through the communication circuit 210, based on the input, in operation 387.

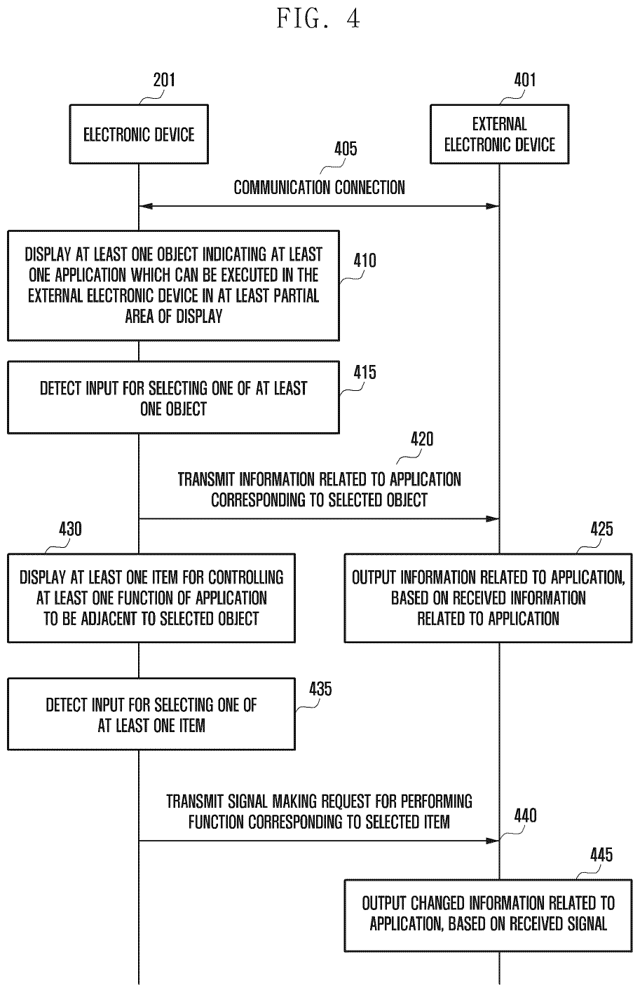

FIG. 4 illustrates a flow of signals between an electronic device and an external electronic device according to an embodiment of the disclosure.

In the following embodiments of the disclosure, respective operations may be sequentially performed but the sequential performance is not necessary. For example, orders of the operations may be changed, and at least two operations may be performed in parallel.

Referring to FIG. 4, since operation 410, operation 415, operation 420, operation 430, operation 435, and operation 440 of FIG. 4 according to various embodiments are the same as operation 315, operation 320, operation 325, operation 330, operation 335, operation 345, operation 350, and operation 355 of FIGS. 3A and 3B, description related thereto may be replaced with the description of FIGS. 3A and 3B.

Referring to FIG. 4, the electronic device 201 may make a communication connection with the external electronic device 401 in operation 405. For example, the electronic device 201 may make the communication connection with the external electronic device 401 in proximity to the electronic device 201 through predetermined communication (for example, short-range wireless communication, such as UWB, Bluetooth, or Bluetooth low energy).

In an embodiment of the disclosure, the electronic device 201 may display at least one object indicating at least one application which can be executed in the external electronic device 401 in at least a partial area (for example, a lower area) (for example, the task bar area) of the display (for example, the display 231 of FIG. 2) in operation 410.

In an embodiment of the disclosure, at least one object indicating at least one application which can be executed in the external electronic device 401 may include at least one object indicating at least one application (for example, at least one application being displayed on the display 231 and/or at least one application being executed in the background) being executed in the electronic device 201, an object indicating an application which has been most frequently executed in the electronic device 201, at least one object indicating at least one application which has been executed in the electronic device 201 a predetermined number of times or more, and/or at least one object indicating at least one application configured as applications frequently used by the user of the electronic device 201. However, the disclosure is not limited thereto, and at least one object indicating at least one application may include at least one object indicating at least one application which has been executed in the external electronic device 401 a predetermined number of times or more and/or an object indicating an application which has been most frequently executed in the external electronic device 401.

In an embodiment of the disclosure, the electronic device 201 may detect an input for selecting one of the at least one object in operation 415. The electronic device 201 may transmit information related to an application corresponding to the selected object to the external electronic device 401 in operation 420. For example, the information related to the application corresponding to the selected object may include identification information for identifying the application, login information (for example, account information) of the application, and/or information related to execution of the application. For example, when the application is an application related to multimedia content, the information related to execution of the application may include information on the reproduction time of the multimedia content. When the application is a browser application, the information related to execution of the application may be link information. However, the disclosure is not limited thereto.

In an embodiment of the disclosure, the external electronic device 401 may output the information related to the application, based on the information related to the application received from the electronic device 201 in operation 425.

For example, when the application is an application related to multimedia content, the external electronic device 401 may output the multimedia content from reproduction time information, based on the information related to execution of the application received from the electronic device 201, for example, reproduction time information of the multimedia content. When it is assumed that the multimedia content is being reproduced in the electronic device 201 or reproduction of the multimedia content is paused, the external electronic device 401 may provide the user with seamless experience by outputting the multimedia content, based on the reproduction time information of the multimedia content received from the electronic device 201.

In an embodiment of the disclosure, the external electronic device 401 may identify whether the application is installed in the external electronic device 401, based on identification information for identifying the application received from the electronic device 201. When the application is installed in the external electronic device 401, the application may be executed and information related to the application may be output. For example, when the external electronic device 401 includes a display and an audio output circuit, the external electronic device 401 may output information related to the application, for example, visual information and/or auditory information. In another example, when the external electronic device 401 includes only an audio output circuit without a display, the external electronic device 401 may output information related to the application, for example, auditory information.

In an embodiment of the disclosure, when it is identified that the application is not installed in the external electronic device 401, the external electronic device 401 may output visual information and/or auditory information inducing installation of the application. After installing the application, the external electronic device 401 may execute the application and output information related to the application.

The disclosure is not limited thereto, and when an application which can replace the application (for example, an application having the same category or a similar category) is installed in the external electronic device 401, the external electronic device 401 may execute the replaced application and output information related to the application through the replaced application.

In an embodiment of the disclosure, the electronic device 201 may display at least one item for controlling at least one function of the application to be adjacent to the selected object in operation 430. For example, when the application is an application related to multimedia content, at least one function of the application may include a function for controlling reproduction of the multimedia content (for example, pause, play, forward, and/or backward). In another example, when the application is an application related to a user interface, at least one function of the application may include a function for controlling the user interface (for example, forward, backward, and/or home). In another example, when the application is a photo application, at least one function of the application may include a function of displaying a previous photo, a function of displaying a next photo, and/or a function of displaying a recommended photo. However, the disclosure is not limited thereto.

In an embodiment of the disclosure, the electronic device 201 may detect an input for selecting one of the at least one item in operation 435. The electronic device 201 may transmit a signal making a request for performing a function corresponding to the selected item to the external electronic device 401 in operation 440.

In an embodiment of the disclosure, the external electronic device 401 may output changed application information, based on the signal received from the electronic device 201 in operation 445.

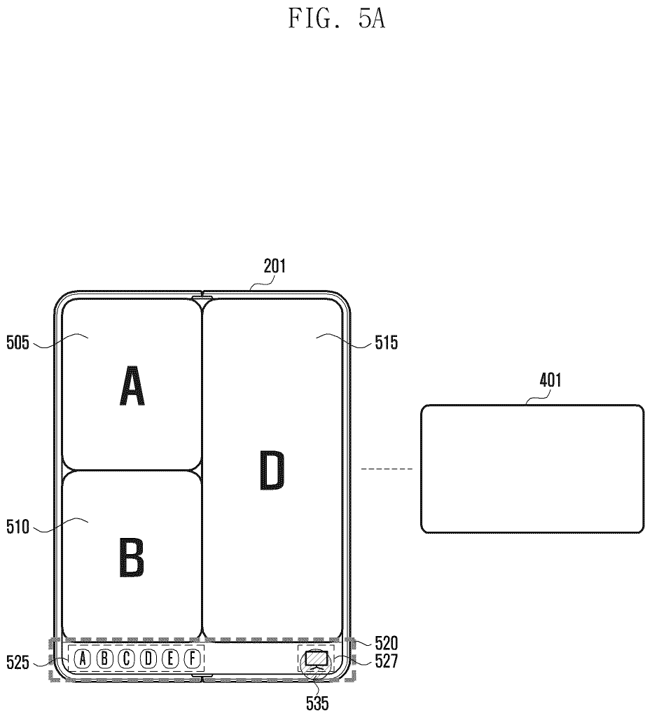

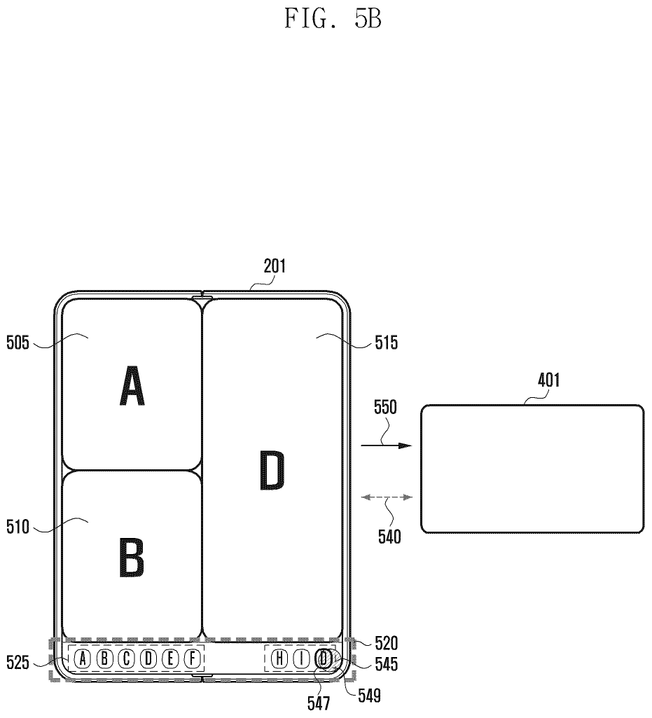

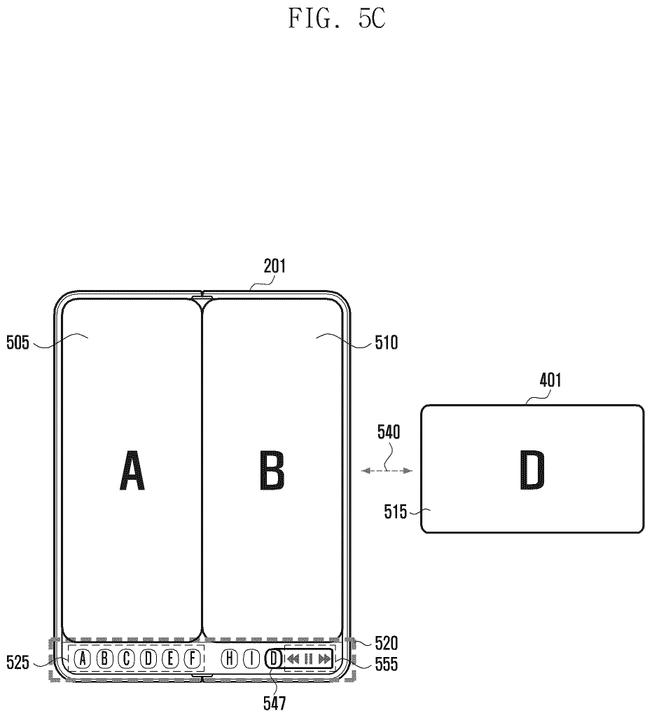

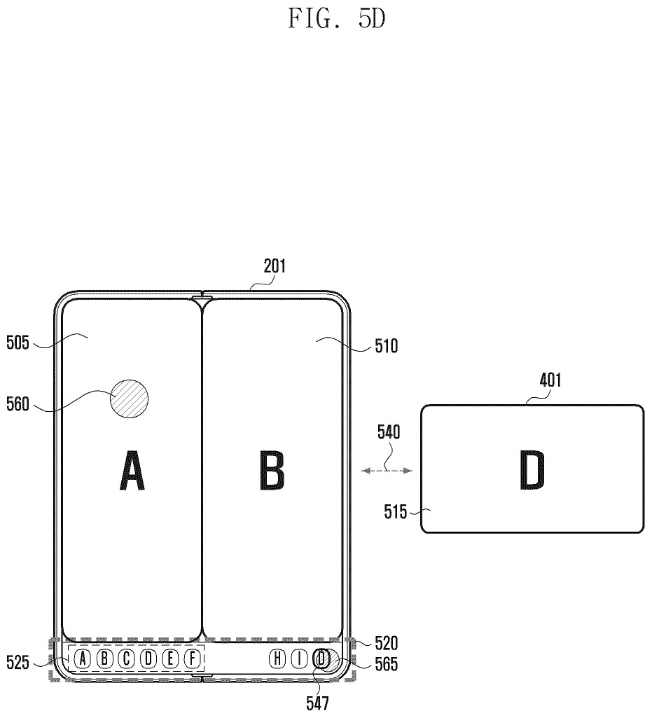

FIGS. 5A, 5B, 5C, and 5D are diagrams illustrating a method by which an electronic device controls an external electronic device according to various embodiments of the disclosure.

Referring to FIG. 5A, as a plurality of applications (for example, an application A, an application B, and an application D) is executed, a processor (for example, the processor 240 of FIG. 2) of an electronic device (for example, the electronic device 201 of FIG. 2) may display screens of the plurality of applications (for example, the application A, the application B, and the application D) (for example, a first screen 505 of the application A, a second screen 510 of the application B, and a third screen 515 of the application D) on a display (for example, the display 231 of FIG. 2) (for example, in a multi-window form). Displaying the screens of the three applications on the display 231 according to execution of the three applications is only an embodiment of the disclosure, and the disclosure is not limited thereto. For example, as applications smaller than or larger than three applications are executed according to the control of the processor 240, the display 231 may display screens of the applications smaller than or larger than three applications. Alternatively, the display 231 may be displaying a home screen.

In an embodiment of the disclosure, the processor 240 may display at least one object indicating at least one application related to the electronic device 201 in at least a partial area of the display 231. For example, the processor 240 may display the task bar area 520 in at least a partial area of the display 231 and display at least one object indicating at least one application related to the electronic device 201 in the task bar area 520. For example, the task bar area may be displayed between the second screen 510 of the application B and the third screen 515 of the application D among the plurality of applications being displayed on the display 231, and the bottom edge of the display 231.

In an embodiment of the disclosure, the task bar area 520 may be displayed in at least a partial area of the display 231 according to detection of a specific input or according to a specific condition. The specific input according to an embodiment may include a swipe input. However, the disclosure is not limited thereto. The specific condition according to an embodiment may include a condition of detecting proximity of at least one external electronic device or a condition of making a communication connection with at least one external electronic device. However, the disclosure is not limited thereto.

In an embodiment of the disclosure, the processor 240 may temporarily display the task bar area 520 in at least a partial area of the display 231. For example, when a predetermined time passes in the state where the task bar area 520 is displayed in at least a partial area of the display 231, the processor 240 may end displaying of the task bar area 520. The disclosure is not limited thereto, and the processor 240 may continuously display the task bar area 520 in at least the partial area of the display 231.

In an embodiment of the disclosure, at least one object indicating at least one application related to the electronic device 201 may include at least one object indicating at least one application (for example, at least one application being displayed on the display 231 and/or at least one application being executed in the background) being executed in the electronic device 201, an object indicating an application which has been most frequently executed in the electronic device 201, at least one object indicating at least one application which has been executed in the electronic device 201 a predetermined number of times or more, and/or at least one object indicating at least one application configured as applications frequently used by the user of the electronic device 201.

In an embodiment of the disclosure, the processor 240 may detect the external electronic device 401 in proximity to the electronic device 201 through a communication circuit (for example, the communication circuit 210 of FIG. 2). For example, the processor 240 may detect proximity of the external electronic device 401 through predetermined communication (for example, short-range wireless communication, such as UWB, Bluetooth, or Bluetooth low energy). When the external electronic device 401 in proximity to the electronic device 201 is detected, the processor 240 may provide a user interface indicating the proximity of the external electronic device 401. For example, the processor 240 may display an object indicating the external electronic device 401 located in proximity to the electronic device 201 in the task bar area 520. Accordingly, in the task bar area 520, at least one object 525 indicating at least one application related to the electronic device 201 and an object 527 indicating the external electronic device 401 located in proximity to the electronic device 201 may be displayed. For example, although not illustrated, the task bar area 520 may include a first area for displaying objects related to the electronic device 201 and a second area for displaying objects related to the external electronic device 401. Accordingly, in the first area, the at least one object 525 indicating at least one application related to the electronic device 201 may be displayed. In the second area, the object 527 indicating the external electronic device 401 located in proximity to the electronic device 201 may be displayed.

In an embodiment of the disclosure, when an input 535 for selecting the object 527 indicating the external electronic device 401 is detected, the processor 240 may make a communication connection 540 with the external electronic device 401 through predetermined communication (for example, short-range wireless communication) as illustrated in FIG. 5B. The disclosure is not limited thereto, and the processor 240 may make the communication connection 540 with the external electronic device 401 through predetermined communication (for example, short-range wireless communication), based on that the external electronic device 401 in proximity to the electronic device 201 is detected without a separate input (for example, the input 535 for selecting the object 527).

In an embodiment of the disclosure, based on the communication connection with the external electronic device 401, the processor 240 may display at least one object 545 indicating at least one application (for example, application H, application I, and/or application D) which can be executed in the external electronic device 401 in the task bar area 520 instead of the object 527 indicating the external electronic device 401 located in proximity to the electronic device 201.

The disclosure is not limited thereto, and although not illustrated, the processor 240 may display at least one object 545 indicating at least one application (for example, application H, application I, and/or application D) which can be executed in the external electronic device 401 in the task bar area 520 along with the object 527 indicating the external electronic device 401 located in proximity to the electronic device 201, based on the communication connection with the external electronic device 401. For example, at least one object 545 indicating at least one application which can be executed in the external electronic device 401 may be displayed to be adjacent to the object 527 indicating the external electronic device 401.

According to an embodiment of the disclosure, the processor 240 may display the application H, the application I, and/or the application D as at least one application which can be executed in the external electronic device 401. For example, as only an application D is displayed as the application which can be executed in the external electronic device 401 among at least one application related to the electronic device 201, for example, an application A, an application B, an application C, the application D, an application E, and an application F, the application A, the application B, the application C, the application E, and the application F may be applications which cannot be executed in the external electronic device 401.

In an embodiment of the disclosure, when an input 549 for selecting one object, for example, an object 547 indicating the application D among at least one object 545 indicating at least one application (for example, the application H, the application I, and/or the application D) which can be executed in the external electronic device 401 is detected, the processor 240 may transmit information related to the application D corresponding to the selected object 547 to the external electronic device 401 through the communication circuit 210 as indicated by reference numeral 550.

The disclosure is not limited thereto, and the processor 240 may transmit information related to the application D displayed in the largest window among screens of the applications executed in the electronic device 201, for example, the first screen 505 of the application A, the second screen 510 of the application B, and the third screen 515 of the application D displayed on the display 231 in a multi-window form to the external electronic device 401 through the communication circuit 210, based on the communication connection with the external electronic device 401.

When the information related to the application D is transmitted to the external electronic device 401 through the screen displayed on the display 231 of the electronic device 201, the processor 240 may remove the third screen 515 of the application D from the display 231 (for example, terminating displaying of the third screen 515 of the application D) and may display only the first screen 505 of the application A and the second screen 510 of the application B on the display 231. However, the disclosure is not limited thereto.

In an embodiment of the disclosure, the external electronic device 401 may output the information related to the application D, based on the information related to the application D received from the electronic device 201. For example, the external electronic device 401 may output visual information (for example, the third screen 515 of the application D) related to the application D to the display and/or output auditory information (for example, an audio signal) of the application D through an audio output circuit.

In an embodiment of the disclosure, based on transmission 550 of the information related to the application D to the external electronic device 401, the processor 240 may display at least one item 555 for controlling functions related to the application D to be adjacent to the object 547 indicating the application D in the task bar area 520 as illustrated in FIG. 5C.

When it is assumed that the application D according to an embodiment is an application related to multimedia content, at least one item 555 for controlling the functions related to the application D may include a first item for reproducing previous multimedia content, a second item for pausing the multimedia content, and/or a third item for reproducing next multimedia content. However, the disclosure is not limited thereto.

Although not illustrated, when the application D is an application related to reproduction of an audio signal, at least one item 555 for controlling the functions related to the application D may include an item for reproducing a previous audio signal, an item for reproducing a next audio signal, and/or an item for pausing the audio signal. However, the disclosure is not limited thereto.

Although not illustrated, when the application D is a photo application, at least one item 555 for controlling the functions related to the application D may include an item for displaying a previous photo, an item for displaying a next photo, and/or an item for displaying a recommended photo. However, the disclosure is not limited thereto.

In an embodiment of the disclosure, the processor 240 may change and display the objects and/or items displayed in the task bar area 520 according to the location at which a user input is detected. For example, referring to FIG. 5D, in the state where the external electronic device 401 outputs the information related to the application D, the processor 240 may detect a user input 560 in the first screen 505 of the application A. In this case, the processor 240 may remove at least one item 555 for controlling the functions related to the application D from the task bar area 520. For example, when the user input 560 is detected on the display 231 of the electronic device 201, the processor 240 may recognize it as the situation where controlling the functions related to the application D being output by the external electronic device 401 is not needed and may remove the display of at least one item 555 for controlling the functions related to the application D from the task bar area 520.

In an embodiment of the disclosure, in the state where the external electronic device 401 outputs the information related to the application D and the state wherein the display of at least one item 555 for controlling the functions related to the application D has been removed from the task bar area 520, the processor 240 may detect an input 565 for selecting the object 547 indicating the application D. In this case, the processor 240 may display at least one item 555 for controlling the functions related to the application D to be adjacent to the object 547 indicating the application D output by the external electronic device 401 in the task bar area 520. For example, when the input 565 for selecting the object 547 indicating the application D is detected, the processor 240 may recognize it as the situation where controlling the functions related to the application D output by the external electronic device 401 is needed and may display at least one item 555 for controlling the functions related to the application D output by the external electronic device 401 to be adjacent to the object 547 indicating the application D in the task bar area 520.

FIGS. 5A to 5D according to various embodiments have described that the number of external electronic devices 401 which are in proximity to the electronic device 201 and have the communication connection therewith is one, but it is only to help understanding of the disclosure and the disclosure is not limited thereto. For example, the external electronic device 401 in proximity to the electronic device 201 may include a plurality of external electronic devices, and the electronic device 201 may make the communication connection with each of the plurality of external electronic devices and perform the operation illustrated in FIGS. 5A to 5D.

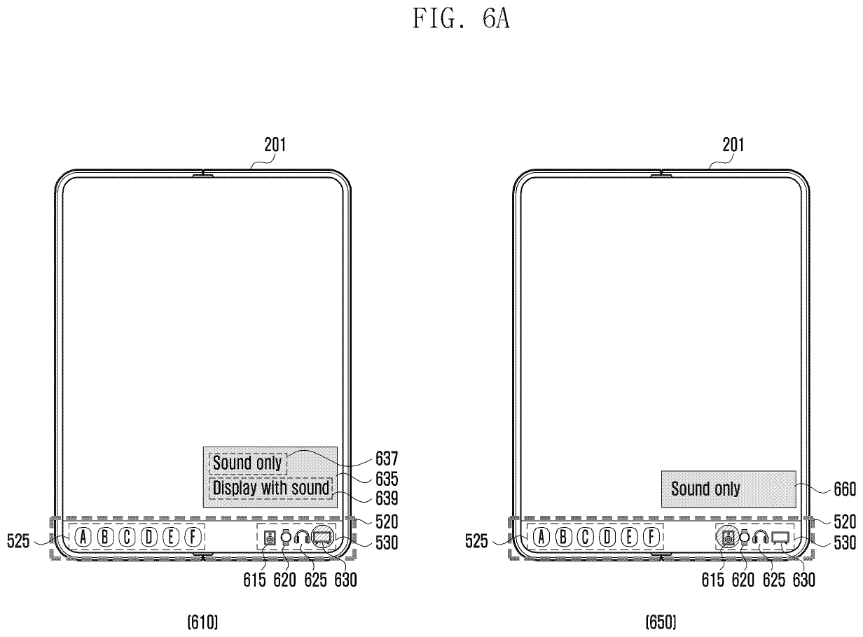

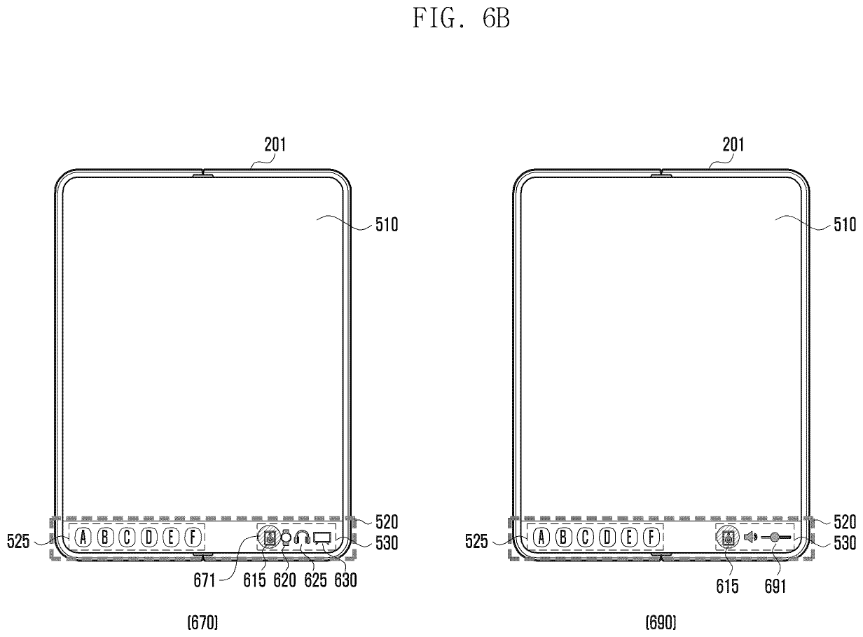

FIG. 6A is a diagram illustrating a method of displaying at least one object indicating at least one scanned external electronic device according to an embodiment of the disclosure.

Referring to FIG. 6A, a processor (for example, the processor 240 of FIG. 2) of an electronic device (for example, the electronic device 201 of FIG. 2) may detect at least one external electronic device in proximity to the electronic device 201 through a communication circuit (for example, the communication circuit 210 of FIG. 2). For example, the processor 240 may detect at least one external electronic device in proximity to the electronic device 201 through predetermined communication (for example, short-range wireless communication, such as UWB, Bluetooth, or Bluetooth low energy).

In an embodiment of the disclosure, the processor 240 may display at least one object 530 indicating at least one external electronic device located in proximity to the electronic device 201 in the task bar area 520 of the display 231. For example, the processor 240 may display the at least one object 525 indicating at least one application related to the electronic device 201 and the at least one object 530 indicating at least one external electronic device in the task bar area 520.

For example, the at least one object 530 may include a first object 615 indicating a first external electronic device, a second object 620 indicating a second external electronic device, a third object 625 indicating a third external electronic device, and/or a fourth object 630 indicating a fourth external electronic device.

In an embodiment of the disclosure, a plurality of objects (for example, the first object 615, the second object 620, the third object 625, and/or the fourth object 630) indicating a plurality of scanned external electronic devices may be displayed differently depending on types of the external electronic devices. In an embodiment of the disclosure, the types of the external electronic devices may include a TV, a watch, a smartphone, a tablet PC, a desktop PC, a laptop PC, a wireless audio output device (for example, a Bluetooth speaker), and a wireless audio wearable electronic device (for example, Bluetooth earphones). For example, the first external electronic device may be a wireless audio output device (for example, a Bluetooth speaker), and the processor 240 may display the first object 615 indicating the wireless audio output device (for example, the Bluetooth speaker). The second external electronic device may be a watch, and the processor 240 may display the second object 620 indicating the watch. The third external electronic device may be a wireless audio wearable electronic device (for example, Bluetooth earphones), and the processor 240 may display the third object 625 indicating the wireless audio wearable electronic device (for example, the Bluetooth earphones). The fourth external electronic device may be a TV, and the processor 240 may display the fourth object 630 indicating the TV.

In an embodiment of the disclosure, the processor 240 may provide a user interface related to information (for example, visual information and/or auditory information) which can be output based on the type of the external electronic device selected from among the plurality of external electronic devices). In this case, the processor 240 may provide a user interface that allows the user to select a type (for example, visual information and/or auditory information) of information to be output to the external electronic device.

For example, as indicated by reference numeral 610, when the selected external electronic device 401 is an external electronic device including a display, the processor 240 may provide a user interface 635 including a first item 637 for outputting only the auditory information and a second item 639 for outputting the visual information and the auditory information. In an embodiment of the disclosure, when the first item 637 for outputting only the auditory information is selected, the processor 240 may transmit, to the external electronic device 401, only information related to auditory information on an application corresponding to an object selected from among at least one object indicating at least one application which is displayed thereafter and can be executed in the external electronic device 401. In an embodiment of the disclosure, when the second item 639 for outputting the visual information and the auditory information is selected, the processor 240 may transmit, to the external electronic device 401, information related to visual information and auditory information on an application corresponding to an object selected from among at least one object indicating at least one application which is displayed thereafter and can be executed in the external electronic device 401.

In another example, as indicated by reference numeral 650, when it is identified that the selected external electronic device 401 is an external electronic device including only an audio output circuit without a display, the processor 240 may provide a user interface 660 including the first item 637 for outputting only the auditory information.

FIG. 6B is a diagram illustrating a method of displaying at least one object indicating at least one external electronic device according to an embodiment of the disclosure.

Referring to FIG. 6B, as indicated by reference numeral 670, a processor (for example, the processor 240 of FIG. 2) of an electronic device (for example, the electronic device 201 of FIG. 2) may display the at least one object 530 indicating at least one external electronic device located in proximity to the electronic device 201 in the task bar area 520 of the display (for example, the display 231 of FIG. 2). For example, when proximity of the external electronic device is detected, the processor 240 may display the at least one object 525 indicating at least one application related to the electronic device 201 and the at least one object 530 (for example, the first object 615 indicating the wireless audio output device (for example, the Bluetooth speaker), the second object 620 indicating the watch, the third object 625 indicting the wireless audio wearable electronic device (for example, the Bluetooth earphones), and/or the fourth object 630 indicating the TV) indicating at least one external electronic device in the task bar area 520.

In an embodiment of the disclosure, the processor 240 may differently display the items for controlling the functions of the external electronic device, based on the type (for example, TV, watch, smartphone, tablet PC, desktop PC, laptop PC, wireless audio output device (for example, Bluetooth speaker), and wireless audio wearable electronic device (for example, Bluetooth earphones) of the external electronic device selected from among the plurality of external electronic devices.

For example, when an input 671 for selecting the first object 615 indicating the first external electronic device indicating the wireless audio output device (for example, the Bluetooth speaker) among the plurality of external electronic devices is detected, an item for controlling auditory information, for example, an item 691 for controlling the volume may be displayed to be adjacent to the first object 615, based on that the selected first external electronic device is a device for outputting only auditory information as indicated by reference numeral 690.

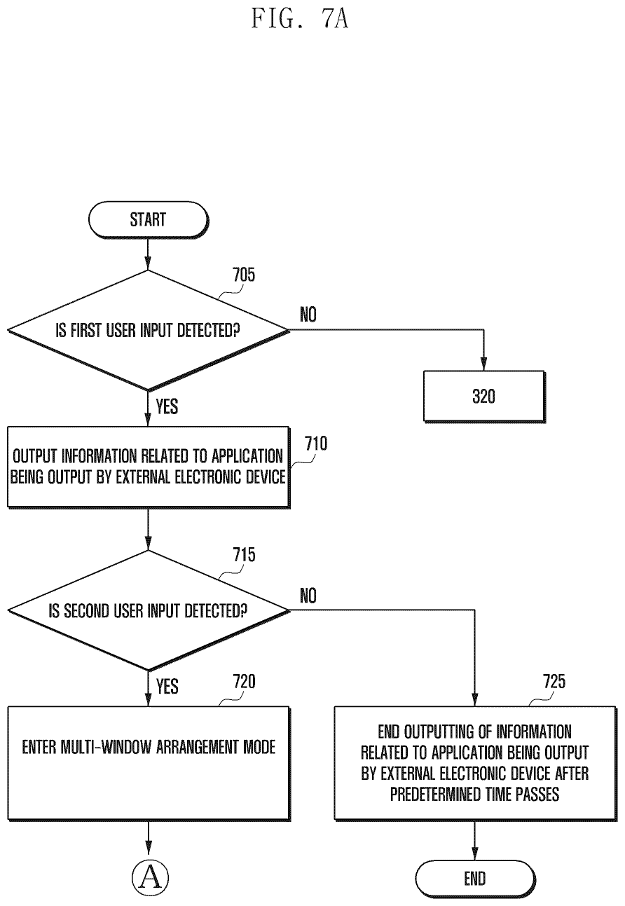

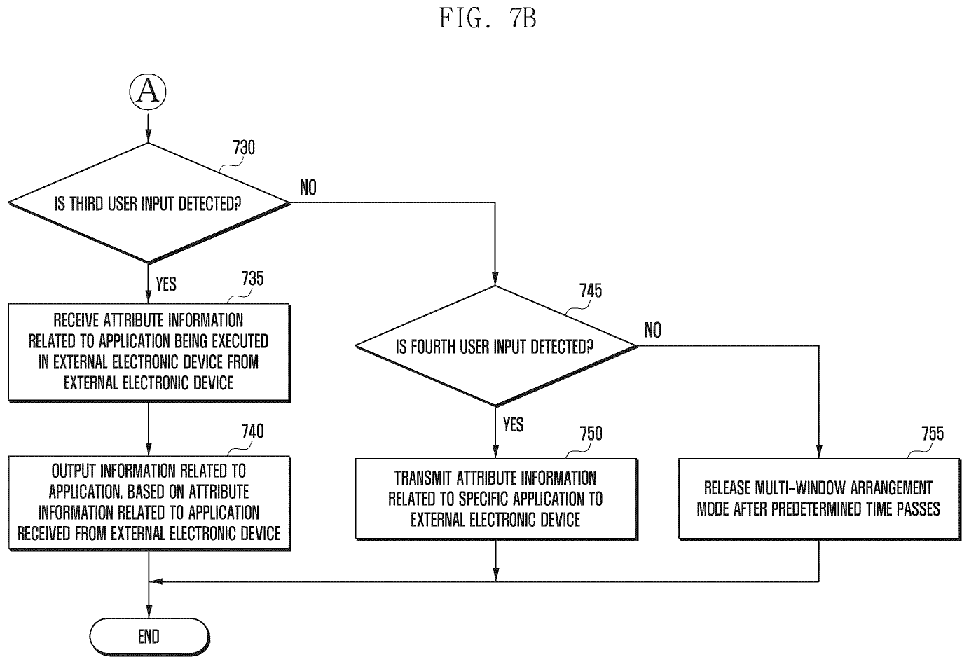

FIGS. 7A and 7B are flowcharts illustrating a method by which an electronic device controls an external electronic device according to various embodiments of the disclosure.

Referring to FIGS. 7A and 7B, in the following embodiments of the disclosure, respective operations may be sequentially performed but the sequential performance is not necessary. For example, orders of the operations may be changed, and at least two operations may be performed in parallel.

According to an embodiment of the disclosure, operation 705 to operation 755 may be understood as being performed by a processor (for example, the processor 240 of FIG. 2) of an electronic device (for example, the electronic device 201 of FIG. 2).

FIGS. 7A and 7B according to various embodiments may be additional operations of FIG. 3B.

Referring to FIGS. 7A and 7B, the processor 240 may identify whether a first user input is detected in operation 705. For example, the processor 240 may identify whether the first user input is detected on at least one item for controlling at least one function of an application. In an embodiment of the disclosure, the first user input may include a long press input. However, the disclosure is not limited thereto.

In an embodiment of the disclosure, when the first user input is detected (for example, yes of operation 705), the processor 240 may output information related to an application being output by the external electronic device 401 in operation 710. For example, the electronic device 201 may output (or display), through a popup window, the information related to the application being output by the external electronic device 401 to be adjacent to at least one item for which the first user input is detected. For example, when the first user input is detected, the processor 240 may transmit a signal making a request for information related to the application which is currently output by the external electronic device 401 to the external electronic device 401. The processor 240 may output (or display) the information related to the application received from the external electronic device 401 through the popup window. For example, when the application is an application related to reproduction of a video, the processor 240 may output (or display), through the popup window, a screen of the application being reproduced in the external electronic device 401 (for example, a video screen or a specific frame screen at a time point at which a request for information related to the currently output application is made), based on the information related to the application received from the external electronic device 401. In another example, when the application is an application related to reproduction of an audio signal, the processor 240 may output (or display), through the popup window, information related to the audio signal being reproduced in the external electronic device 401 (for example, title, singer name, and/or album image), based on the information related to the application received from the external electronic device 401.

In an embodiment of the disclosure, when the first user input is not detected (for example, no of operation 705), the processor 240 may maintain the state where at least one item for controlling at least one function of the application is displayed to be adjacent to the selected object in operation 320 of FIG. 3A.

In an embodiment of the disclosure, the processor 240 may identify whether a second user input is detected in operation 715. For example, the processor 240 may identify whether the second user input is detected in a popup window for the information related to the application being output by the external electronic device 401. In an embodiment of the disclosure, the second user input may include a long press input. However, the disclosure is not limited thereto.

In an embodiment of the disclosure, when the second user input is detected (for example, yes of operation 715), the processor 240 may enter a multi-window arrangement mode in operation 720. After entering the multi-window arrangement mode, the processor 240 may identify whether a third user input is detected in operation 730. In an embodiment of the disclosure, the third user input may include a drag & drop input. However, the disclosure is not limited thereto. In an embodiment of the disclosure, the processor 240 may identify whether the third user input (for example, the drag & drop input) for selecting the popup window for the information related to the application being output by the external electronic device 401 and moving and dropping the popup window to a specific area of the display (for example, the display 231 of FIG. 2).

In an embodiment of the disclosure, when the third user input is detected (for example, yes of operation 730), the processor 240 may receive the information related to the application being executed in the external electronic device from the external electronic device in operation 735. For example, the information related to the application may include identification information for identifying the application, login information (for example, account information) of the application, and/or information related to execution of the application. When the application is an application related to multimedia content, the information related to execution of the application may include reproduction time information of the multimedia content. When the application is a browser application, the information related to execution of the application may be link information.

In an embodiment of the disclosure, the processor 240 may output the information related to the application, based on the information related to the application received from the external electronic device 401 in operation 740. For example, the processor 240 may output visual information (for example, a screen) of the application to the display 231 and/or output auditory information (for example, an audio signal) of the application through an audio output circuit. In this case, the processor 240 may display at least one object indicating at least one application which can be executed in the external electronic device 401 in the task bar area 520 instead of displaying at least one item for controlling at least one function of the application being output by the external electronic device 401.

In an embodiment of the disclosure, when the third user input is not detected (for example, no of operation 730), the processor 240 may identify whether a fourth user input is detected in operation 745. For example, the fourth user input may include a drag & drop input. However, the disclosure is not limited thereto. In an embodiment of the disclosure, after entering the multi-window arrangement mode by the second user input (for example, the long press input), the processor 240 may identify whether the fourth user input (for example, the drag & drop input) for selecting a screen of a specific application being displayed on the display 231 and moving and dropping the screen to a popup window for information related to the application being output by the external electronic device 401.

In an embodiment of the disclosure, when the fourth user input is detected (for example, yes of operation 745), the processor 240 may transmit information related to a specific application to the external electronic device in operation 750. In this case, the processor 240 may display an object indicating the specific application transmitted by the electronic device 201 and/or at least one object for controlling at least one function of the specific application in the task bar area 520 instead of displaying at least one item for controlling at least one function of the application being output by the external electronic device 401.

In an embodiment of the disclosure, when the fourth user input is not detected (for example, no of operation 745), the processor 240 may release the multi-window arrangement mode after a predetermined time passes in operation 755.

In an embodiment of the disclosure, when the second user input is not detected (for example, no of operation 715), the processor 240 may end outputting of the information related to the application being output by the external electronic device 401 after a predetermined time passes in operation 725.

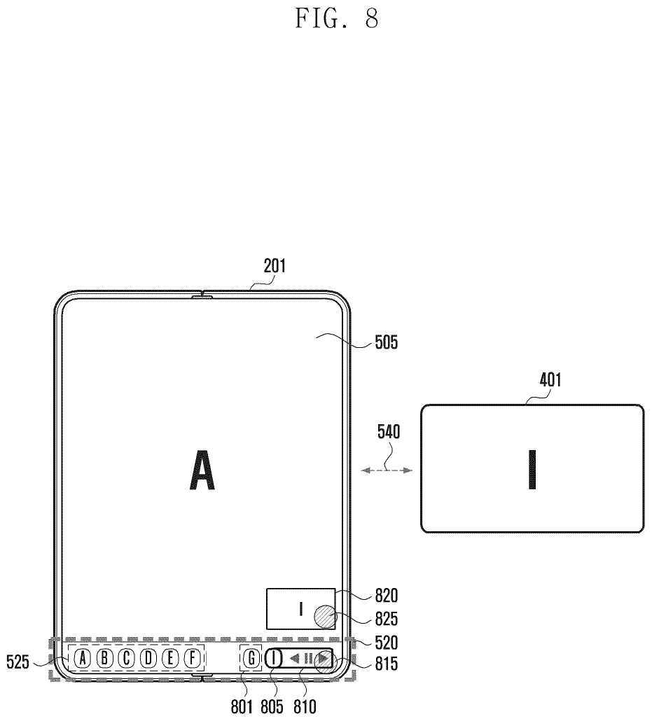

FIG. 8 is a diagram illustrating a method by which an electronic device controls an external electronic device according to an embodiment of the disclosure.

Referring to FIG. 8, a processor (for example, the processor 240 of FIG. 2) of an electronic device (for example, the electronic device 201 of FIG. 2) may display the first screen 505 of the application A on a display (for example, the display 231 of FIG. 2). The processor 240 may have the communication connection 540 with the external electronic device 401 in proximity to the electronic device 201 through a communication circuit (for example, the communication circuit 210 of FIG. 2).

Referring to FIG. 8, it is assumed and described that the processor 240 transmits information related to the application I to the external electronic device 401 having the communication connection 540.

In an embodiment of the disclosure, the external electronic device 401 may output information related to the application I (for example, visual information and/or auditory information), based on the information related to the application received from the electronic device 201.

In an embodiment of the disclosure, the processor 240 may display the at least one object 525 indicating at least one application being executed in the electronic device 201, at least one object (for example, an object 801 indicating the application G) indicating at least one application which can be executed in the external electronic device 401, an object 805 indicating the application I being executed in the external electronic device 401, and/or at least one item 810 for controlling at least one function of the application I in the task bar area 520.

In an embodiment of the disclosure, the processor 240 may detect a first user input 815 on at least one item 810 for controlling at least one function of the application I being executed in the external electronic device 401. For example, the first user input may include a long press input. However, the disclosure is not limited thereto.

In an embodiment of the disclosure, based on that the first user input 815 is detected, the processor 240 may display information related to the application I being output by the external electronic device 401 to be adjacent to at least one item 810 through a popup window 820.

In an embodiment of the disclosure, the processor 240 may detect a second user input 825. For example, the second user input 825 may include a long press input in the popup window 820.

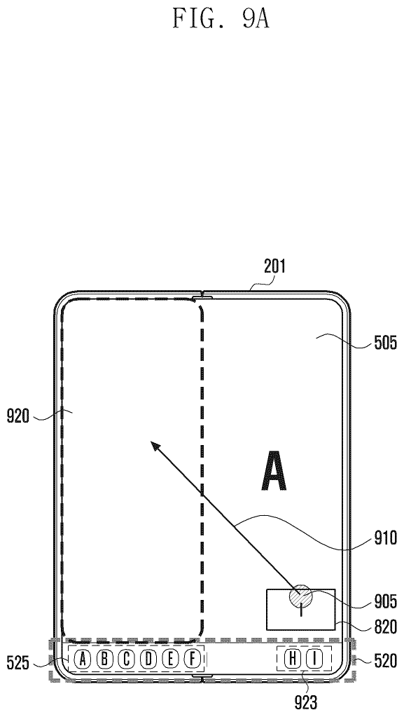

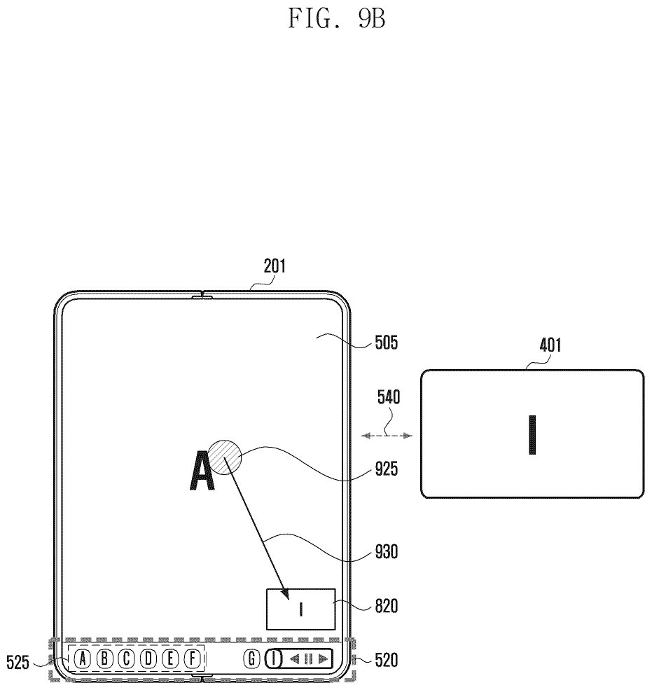

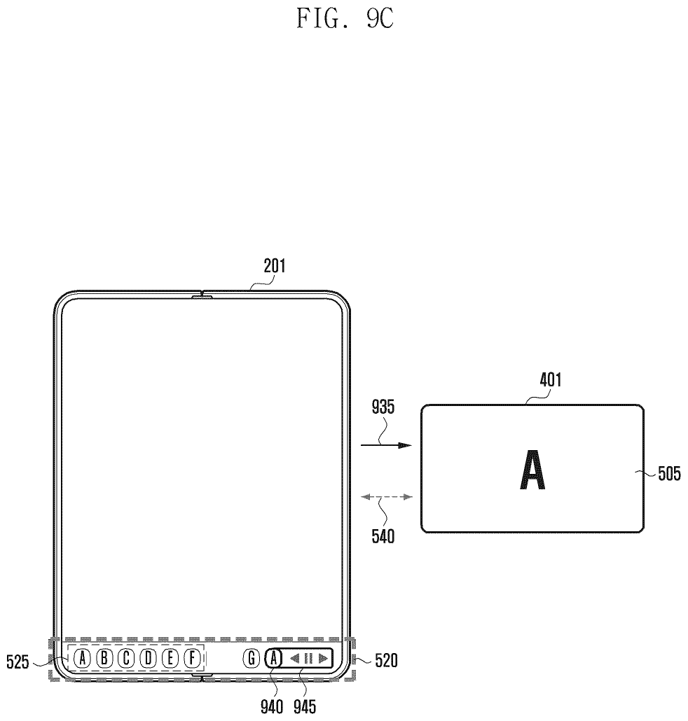

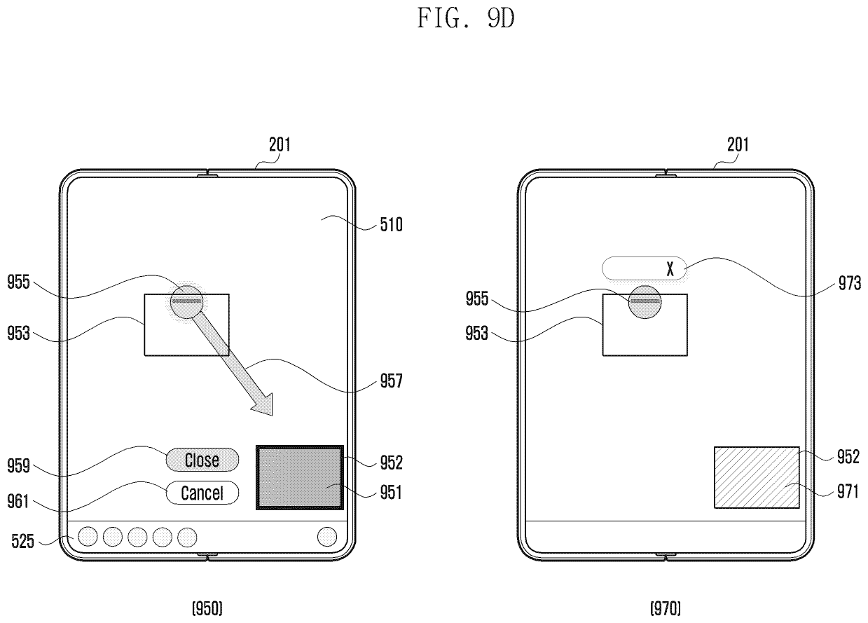

In an embodiment of the disclosure, based on that the second user input 825 is detected, the processor 240 may enter a multi-window arrangement mode. In FIGS. 9A, 9B, 9C, and 9D described below in connection with this, various embodiments will be described.

FIGS. 9A, 9B, 9C, and 9D are diagrams illustrating a method by which an electronic device controls an external electronic device according to various embodiments of the disclosure.

In an embodiment of the disclosure, although not illustrated, a processor (for example, the processor 240 of FIG. 2) of an electronic device (for example, the electronic device 201 of FIG. 2) may enter a multi-window arrangement mode when a second user input (not shown) (for example, a long press input) is detected in the state where the first screen 505 of the application A is displayed on a display (for example, the display 231 of FIG. 2).

Referring to FIG. 9A, the processor 240 may detect a third user input 905 and 910 in the multi-window arrangement mode. For example, the third user input 905 and 910 may include a drag & drop input for moving and dropping the popup window to a specific area of the display 231 in the state where the popup window 820 for information related to the application I being output by the external electronic device 401 is selected.

In an embodiment of the disclosure, based on that the input for moving the popup window to the specific area of the display 231 in the state where the popup window 820 is selected, the processor 240 may display information related to the application I being output by the external electronic device 401 in an area 920 of the display 231.

In an embodiment of the disclosure, when the popup window is moved to the specific area of the display 231 in the state where the popup window 820 is selected and then the popup window is released (for example, dropped) in at least a partial area of the display 231, the processor 240 may make a request for information related to the application I being executed in the external electronic device 401 to the external electronic device 401. In response to the request for information related to the application I being executed in the external electronic device 401 to the external electronic device 401, the processor 240 may receive the information related to the application I from the external electronic device 401. For example, the information related to the application I may include identification information for identifying the application I, login information (for example, account information) of the application I, and/or information related to execution of the application. When the application I is an application related to multimedia content, information related to execution of the application I may include reproduction time information of the multimedia content. When the application I is a browser application, information related to execution of the application I may be link information.

In an embodiment of the disclosure, the processor 240 may output the information related to the application I, based on the information related to the application I received from the external electronic device 401. For example, based on that the processor enters the multi-window arrangement mode and detects the third user input 905 and 910 in the state where the first screen 505 of the application A is displayed on the display, the processor 240 may display the first screen 505 of the application A and the screen 920 of the application I in the multi-window form. In this case, although not illustrated, the external electronic device 401 may end the outputting of the information related to the application I. Further, the processor 240 may display at least one object 923 indicating at least one application (for example, the application H and/or the application I) which can be executed in the external electronic device 401 instead of displaying at least one item for controlling the functions related to the application I in the task bar area 520.

In another embodiment of the disclosure, referring to FIG. 9B, in the multi-window arrangement mode, the processor 240 may detect a fourth user input 925 and 930. For example, the fourth user input 925 and 930 may include a drag & drop input for moving and dropping the first screen 505 of the application A being displayed on the display 231 to the popup window 820 (for example, the popup window for information related to the application I being output by the external electronic device 401).

In an embodiment of the disclosure, based on that the fourth user input 925 and 930 is detected, the processor 240 may transmit the information related to the application A to the external electronic device 401 as indicated by reference numeral 935 of FIG. 9C.

In an embodiment of the disclosure, based on that the information related to the application A is transmitted to the external electronic device 401 as indicated by reference numeral 935, the processor 240 may remove the display of the first screen 505 of the application A from the display 231 (or end the display of the first screen 505 of the application A). However, the disclosure is not limited thereto.

In an embodiment of the disclosure, when the display of the first screen 505 of the application A is removed from the display 231 as the information related to the application A is transmitted to the external electronic device 401 as indicated by reference numeral 935, the processor 240 may remove the display of the object indicating the application A from the task bar area 520. For example, the application A does not correspond to an application being executed in the background, a most frequently executed application, or an application which has been executed in the electronic device 201 a predetermined number of times or more, but may be an application which is not configured as a frequently used application. In this case, based on that the information related to the application A is transmitted to the external electronic device 401 as indicated by reference numeral 935, the processor 240 may remove the object indicating the application A from the at least one object 525 indicating at least one application related to the electronic device 205 displayed in the task bar area 520.

In an embodiment of the disclosure, based on that the information related to the application A is received from the electronic device 201, the external electronic device 401 may output the information related to the application A instead of outputting the information related to the application I. In this case, in the task bar area 520, an object 940 indicating the application A being executed in the external electronic device 401 and at least one item 945 for controlling at least one function related to the application A may be displayed.

Referring to reference numeral 950 of FIG. 9D, the processor 240 may output a screen of a specific application on the display 231 through a popup window 953. The processor 240 may detect a user input 955 and 957. The user input 955 and 957 may include a drag input for moving the popup window 953 in a specific direction in the state where the popup window is selected. However, the disclosure is not limited thereto, and the user input may be a touch input 955 for selecting the popup window 953.

In an embodiment of the disclosure, based on the user input 955 and 957 is detected, the processor 240 may display a first item 959 for ending displaying of the popup window 953 and a second item 961 for canceling the moving of the popup window 953

In an embodiment of the disclosure, when the user input 955 and 957 is released (for example, dropped) on the first item 959, the processor 240 may end displaying of the popup window 953. When the user input 955 and 957 is released (for example, dropped) on the second item 961, the processor 240 may maintain displaying of the popup window 953.

In an embodiment of the disclosure, based on that the user input 955 and 957 is detected, the processor 240 may identify whether a specific application being displayed on the display 231 is an application supported by the external electronic device 401 (for example, whether the specific application is an application installed in the external electronic device 401 or whether an application which can replace the specific application is installed in the external electronic device 401). For example, based on information received from the external electronic device 401 during a process of making the communication connection with the external electronic device 401, the processor 240 may identify whether the specific application being displayed on the display 231 is an application supported by the external electronic device 401. In another example, based on that the user input 955 and 957 is detected, the processor 240 may transmit a signal making a request for identifying whether the specific application being displayed on the display 231 is an application supported by the external electronic device 401 to the external electronic device 401. Based on the request signal, the external electronic device 401 may identify whether the specific application being displayed on the display 231 is an application supported by the external electronic device 401.

In an embodiment of the disclosure, when it is identified that the specific application being displayed on the display 231 is an application which is not supported by the external electronic device 401, the processor 240 may output a first visual effect 951 (for example, a shading effect) to a popup window 952 for information related to the application being output by the external electronic device 401. For example, the first visual effect 951 (for example, the shading effect) may be a visual effect indicating that the specific application is the application which is not supported by the external electronic device 401.

In an embodiment of the disclosure, referring to reference numeral 970, when a touch input 955 for selecting the popup window 953 is detected, an item 973 for ending displaying of the popup window 953 may be displayed to be adjacent to the popup window 953. When an input for selecting the item 973 is detected, the processor 240 may end displaying of the popup window 953.

In an embodiment of the disclosure, based on that the touch input 955 is detected, the processor 240 may identify whether the specific application being displayed on the display 231 is an application supported by the external electronic device 401. In an embodiment of the disclosure, when it is identified that the specific application being displayed on the display 231 is an application supported by the external electronic device 401, the processor 240 may output a second visual effect 971 (for example, a highlight effect) to the popup window 952 for information related to the application being output by the external electronic device 401. For example, the second visual effect 971 (for example, the highlight effect) may be a visual effect indicating that the specific application is the application supported by the external electronic device 401.

In an embodiment of the disclosure, although not illustrated, when a user input (for example, a touch input) is detected in the popup window 952 for information related to the application being output by the external electronic device 401, the processor 240 may display an item for ending outputting of the information related to the application by the external electronic device 401. The disclosure is not limited thereto, and when the user input (for example, the touch input) is detected in the popup window 952 for information related to the application being output by the external electronic device 401, the processor 240 may display the item for ending outputting of the information related to the application by the external electronic device 401. When an input for selecting the item for ending outputting of the information related to the application by the external electronic device 401 is detected, the processor 240 may transmit a signal making a request for ending the outputting of the information related to the application to the external electronic device 401.

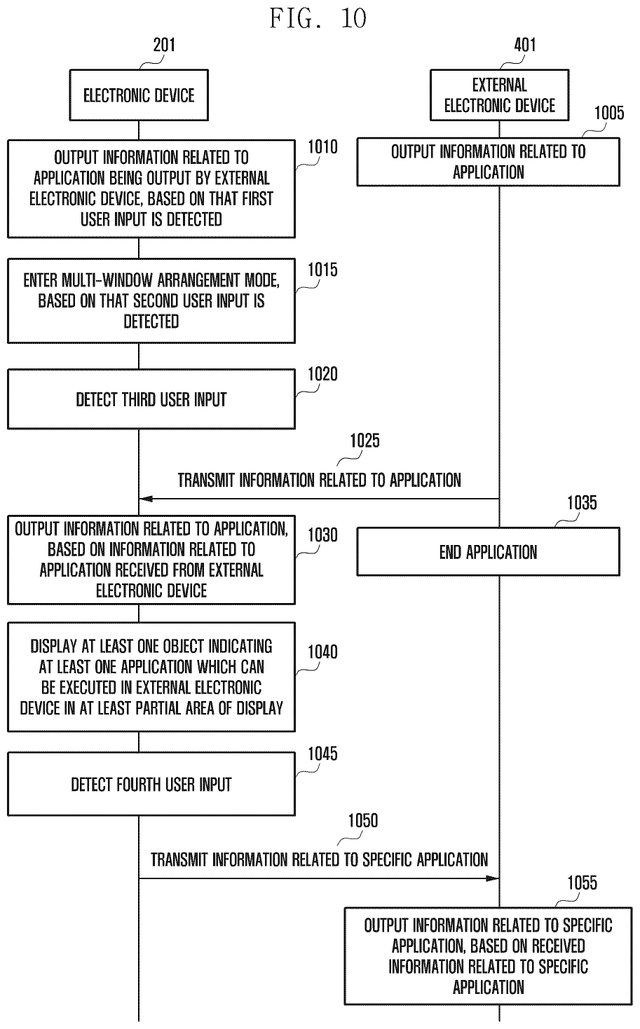

FIG. 10 illustrates a flow of signals between an electronic device and an external electronic device according to an embodiment of the disclosure.

In the following embodiments of the disclosure, respective operations may be sequentially performed but the sequential performance is not necessary. For example, orders of the operations may be changed, and at least two operations may be performed in parallel.

Referring to FIG. 10, since operation 1010, operation 1015, operation 1020, operation 1030, operation 1040, operation 1045, and operation 1050 of FIG. 10 according to various embodiments are the same as operation 705, operation 710, operation 715, operation 720, operation 730, operation 735, operation 740, operation 745, and operation 750 of FIGS. 7A and 7B, description related thereto may be replaced with the description of FIGS. 7A and 7B.

Referring to FIG. 10, the external electronic device 401 may be outputting information on an application in operation 1005.

In an embodiment of the disclosure, based on that a first user input is detected, the electronic device 201 may display information related to the application being output by the external electronic device 401 in a task bar area (for example, the task bar area 520) in operation 1010. For example, the electronic device 201 may detect the first user input on at least one item for controlling at least one function of the application being output by the external electronic device 401 being displayed in the task bar area 520. When the first user input is detected, the electronic device 201 may display, through a popup window, information related to the application being output by the external electronic device 401 to be adjacent to at least one item on which the first user input has been detected.

In an embodiment of the disclosure, the electronic device 201 may enter a multi-window arrangement mode, based on that a second user input is detected, in operation 1015. For example, the electronic device 201 may detect the second user input in the popup window for information related to the application being output by the external electronic device 401. The electronic device 201 may detect a third user input in operation 1020. For example, the electronic device 201 may detect the third user input for moving from the popup window for the information related to the application being output by the external electronic device 401 to a specific area of the display 231.

In an embodiment of the disclosure, based on that the third user input is detected, the electronic device 201 may receive information related to the application from the external electronic device 401 in operation 1025. For example, the information related to the application may include identification information for identifying the application, login information (for example, account information) of the application, and/or information related to execution of the application. When the application is an application related to multimedia content, the information related to execution of the application may include reproduction time information of the multimedia content. When the application is a browser application, the information related to execution of the application may be link information.

In an embodiment of the disclosure, although not illustrated, the electronic device 201 may further perform an operation of transmitting a signal making a request for information related to the application being executed in the external electronic device 401, based on that the third user input is detected.

In an embodiment of the disclosure, the electronic device 201 may output the information related to the application, based on the information related to the application received from the external electronic device 401, in operation 1030. For example, the electronic device 201 may output visual information (for example, a screen) of the application to the display 231 and/or output auditory information (for example, an audio signal) of the application through an audio output circuit.

In an embodiment of the disclosure, the external electronic device 401 may end the application in operation 1035.

In an embodiment of the disclosure, the electronic device 201 may display at least one object indicating at least one application which can be executed in the external electronic device 401 in the task bar area 520 in operation 1040. The electronic device 201 may detect a fourth user input in operation 1045. For example, the electronic device 201 may detect the fourth user input for moving from a screen of a specific application being displayed on the display 231 to a popup window for information related to the application being output by the external electronic device 401. Based on that the fourth user input is detected, the electronic device 201 may transmit information related to the specific application to the external electronic device 401 in operation 1050.

In an embodiment of the disclosure, the external electronic device 401 may output information related to the specific application, based on the information related to the specific application received from the electronic device 201 in operation 1055. For example, when the external electronic device 401 includes a display and an audio output circuit, the external electronic device 401 may output information related to the specific application, for example, visual information and/or auditory information, based on the information related to the specific application. In another example, when the external electronic device 401 includes only an audio output circuit without a display, the external electronic device 401 may output information related to the specific application, for example, auditory information, based on the information related to the specific application.

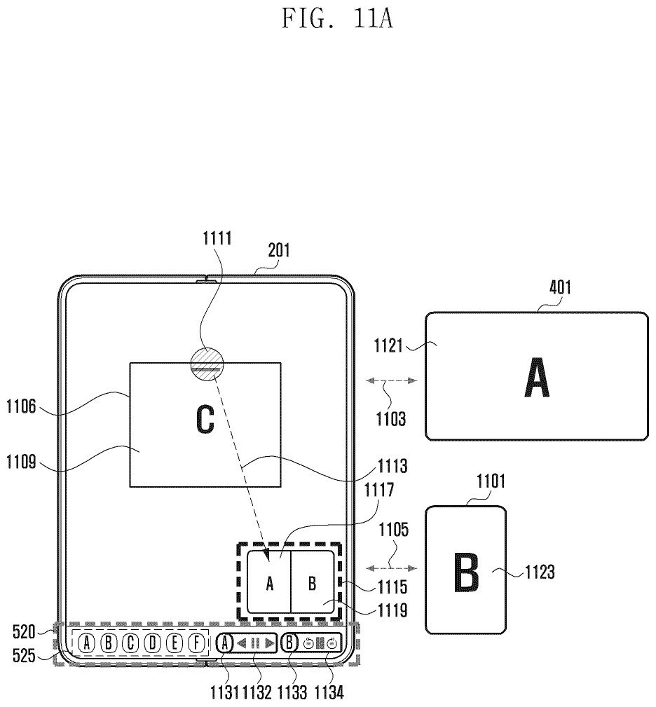

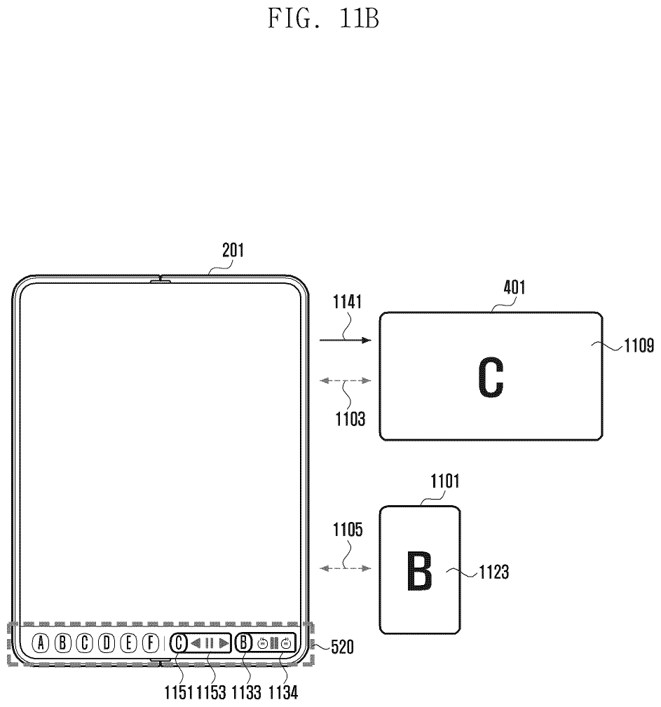

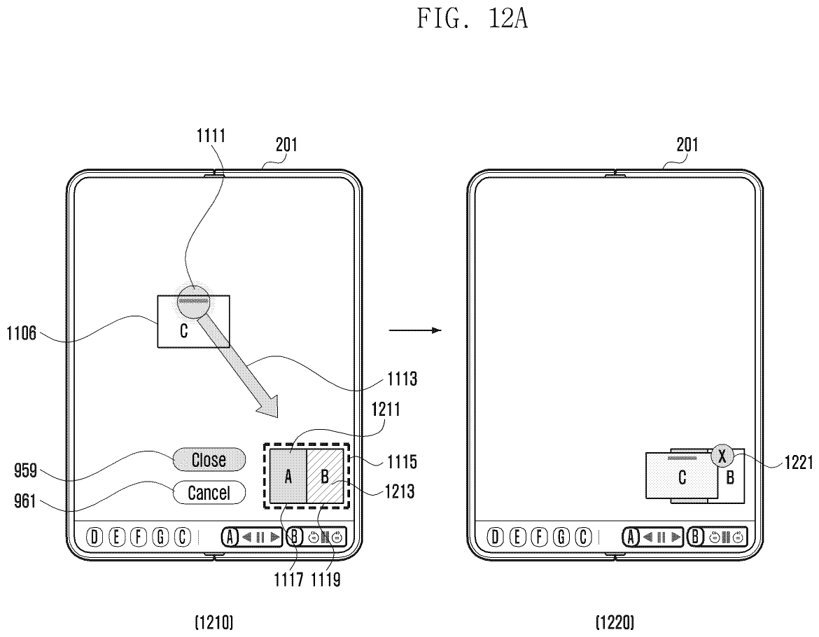

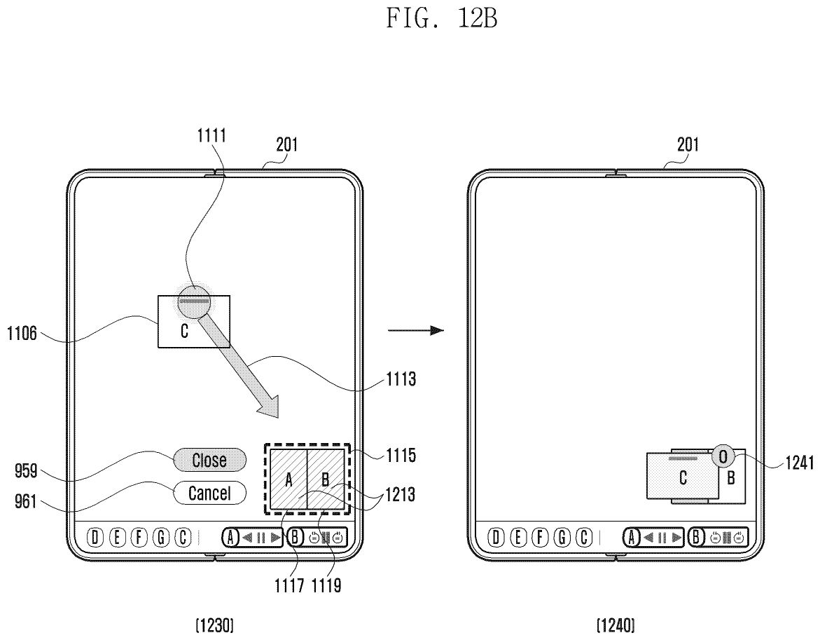

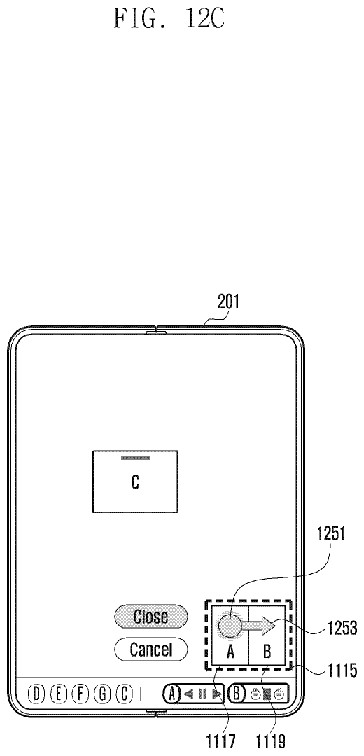

It has been described that the number of external electronic devices 401 which are in proximity to the electronic device 201 and having the communication connection is one in FIGS. 3A to 3C, 4, 5A to 5D, 6A, 6B, 7A, 7B, 8, 9A to 9D, and 10 according to various embodiments of the disclosure, but it is only to help understanding of the disclosure and the disclosure is not limited thereto. For example, the external electronic device 401 in proximity to the electronic device 201 may include a plurality of external electronic devices, and the electronic device 201 may make the communication connection with each of the plurality of external electronic devices and perform the operations illustrated in FIGS. 3A to 3C, 4, 5A to 5D, 6A, 6B, 7A, 7B, 8, 9A to 9D, and 10. In connection with this, various embodiments will be described in FIGS. 11A, 11B, 12A, and 12B below.

FIGS. 11A and 11B are diagrams illustrating a method by which an electronic device controls a plurality of external electronic devices according to various embodiment of the disclosure.

Referring to FIGS. 11A and 11B, a processor (for example, the processor 240 of FIG. 2) of an electronic device (for example, the electronic device 201 of FIG. 2) may display information 1109 related to an application C on a display (for example, the display 231 of FIG. 2) through a popup window 1106 as the application C is executed. In an embodiment of the disclosure, the processor 240 may display the at least one object 525 indicating at least one application related to the electronic device 201 in the task bar area 520. For example, the at least one object 525 indicating at least one application related to the electronic device 201 may include at least one object indicating at least one application (for example, at least one application being displayed on the display 231 and/or at least one application being executed in the background) being executed in the electronic device 201, an object indicating an application which has been most frequently executed in the electronic device 201, at least one object indicating at least one application which has been executed in the electronic device 201 a predetermined number of times or more, and/or at least one object indicating at least one application configured as applications frequently used by the user of the electronic device 201. However, the disclosure is not limited thereto.

In an embodiment of the disclosure, the processor 240 may detect a first external electronic device 401 and a second external electronic device 1101 which are in proximity to the electronic device 201 through a communication circuit (for example, the communication circuit 210 of FIG. 2). For example, the processor 240 may detect the first external electronic device 401 and the second external electronic device 1101 which are in proximity to the electronic device 201 through predetermined communication (for example, short-range wireless communication, such as UWB, Bluetooth, or Bluetooth low energy). Based on that the first external electronic device 401 and the second external electronic device 1101 which are in proximity to the electronic device 201 are detected, the processor 240 may make communication connections 1103 and 1105 with the first external electronic device 401 and the second external electronic device 1101 through predetermined communication (for example, short-range wireless communication).

Referring to FIG. 11A, it is assumed and described that the first external electronic device 401 outputs information 1121 related to an application A as the information related to the application A is transmitted to the first external electronic device 401 having the communication connection with the electronic device 201, and the second external electronic device 1101 outputs information 1123 related to an application B as the information related to the application B is transmitted to the second external electronic device 1101. In this case, the processor 240 may further display a first object 1131 indicating the application A being executed in the first external electronic device 401 having the communication connection 1103 with the electronic device 201 and a second object 1133 indicating the application B being executed in the second external electronic device 1101 having the communication connection 1105 with the electronic device 201 in the task bar area 520. The disclosure is not limited thereto, and the processor 240 may display at least one item 1132 for controlling at least one function related to the application A to be adjacent to the first object 1131 indicating the application A and display at least one item 1134 for controlling at least one function related to the application B to be adjacent to the second object 1133 indicating the application B.

In an embodiment of the disclosure, the processor 240 may identify whether a user input (for example, a long press input) is detected on at least one item 1132 for controlling at least one function related to the application A displayed in the task bar area 520 or at least one item 1134 for controlling at least one function related to the application B. When the user input (for example, the long press input) is detected, the processor 240 may display information 1117 related to the application A being output by the first external electronic device 401 and information 1119 related to the application B being output by the second external electronic device 1101 on the display 231 through a popup window 1115. For example, when the user input (for example, the long press input) is detected, the processor 240 may transmit a signal making a request for information related to the application A being currently output by the first external electronic device 401 to the first external electronic device 401. The processor 240 may display the information 1117 related to the application A received from the first external electronic device 401 through the popup window 1115. Further, when the user input (for example, the long press input) is detected, the processor 240 may transmit a signal making a request for information related to the application B being currently output by the second external electronic device 1101 to the second external electronic device 1101. The processor 240 may display the information 1119 related to the application B received from the second external electronic device 1101 through the popup window 1115.

In an embodiment of the disclosure, after selecting a popup window 1106 for an application C being displayed on the display 231, the processor 240 may detect a drag & drop input 1111 and 1113 for moving and dropping the popup window to the information 1117 related to the application A displayed on the popup window 1115. Based on that the drag & drop input 1111 and 1113 is detected, the processor 240 may transmit information related to the application C to the first external electronic device 401 as indicated by reference number 1141 of FIG. 11B.

In an embodiment of the disclosure, based on that the information related to the application C is received from the electronic device 201, the first external electronic device 401 may output information 1109 related to the application C instead of outputting information 1121 related to the application A. In this case, instead of the first object 1131 indicating the application A and at least one item 1132 for controlling at least one function related to the application A, a third object 1151 indicating the application C and at least one item 1153 for controlling at least one function related to the application C may be displayed in the task bar area 520.

FIGS. 12A, 12B, and 12C are diagrams illustrating a method by which an electronic device controls a plurality of external electronic devices according to various embodiments of the disclosure.

Referring to FIG. 12A, a processor (for example, the processor 240 of FIG. 2) of an electronic device (for example, the electronic device 201 of FIG. 2) may output a screen of an application C to a display (for example, the display 231 of FIG. 2) through a popup window 1106.

In an embodiment of the disclosure, the processor 240 may detect a first external electronic device (for example, the first external electronic device 401 of FIGS. 11A and 11B) and a second external electronic device (for example, the second external electronic device 1101 of FIGS. 11A and 11B) which are in proximity to the electronic device 201 through a communication circuit (for example, the communication circuit 210 of FIG. 2). Based on that the first external electronic device 401 and the second external electronic device 1101 which are in proximity to the electronic device 201 are detected, the processor 240 may make communication connections with the first external electronic device 401 and the second external electronic device 1101 through predetermined communication (for example, short-range wireless communication).

Referring to FIGS. 12A and 12B, it is assumed and described that the first external electronic device 401 outputs information 1121 related to an application A as the information related to the application A is transmitted to the first external electronic device 401 having the communication connection with the electronic device 201, and the second external electronic device 1101 outputs information 1123 related to an application B as the information related to the application B is transmitted to the second external electronic device 1101.

In an embodiment of the disclosure, the processor 240 may detect a user input (e.g., the drag & drop input 1111 and 1113). For example, the drag & drop input 1111 and 1113 may include a drag & drop input for moving the popup window 1106 in a specific direction in the state where the popup window 1106 is selected. However, the disclosure is not limited thereto, and the user input may be touch input for selecting the popup window 1106.

In an embodiment of the disclosure, based on that the drag & drop input 1111 and 1113 is detected, the processor 240 may display a first item 959 for ending displaying of the popup window 1106 and a second item 961 for canceling moving of the popup window 1106.

In an embodiment of the disclosure, based on that the drag & drop input 1111 and 1113 is detected, the processor 240 may identify whether the application C being displayed on the display 231 is an application supported by the first external electronic device 401 and/or the second external electronic device 1101 (for example, whether a specific application is an application installed in the external electronic device 401 or whether an application which can replace the specific application is installed in the external electronic device 401). For example, based on information received from the first external electronic device 401 and/or the second external electronic device 1101 during a process of making the communication connection with the first external electronic device 401 and/or the second external electronic device 1101, the processor 240 may identify whether the application C being displayed on the display 231 is the application supported by the first external electronic device 401 and/or the second external electronic device 1101. In another example, based on that the drag & drop input 1111 and 1113 is detected, the processor 240 may transmit a signal making a request for identifying whether the application C being displayed on the display 231 is the application supported by the first external electronic device 401 and/or the second external electronic device 1101 to the first external electronic device 401 and/or the second external electronic device 1101. Based on the request signal, the processor 240 may identify whether the application C being displayed on the display 231 is the application supported by the first external electronic device 401 and/or the second external electronic device 1101.

In an embodiment of the disclosure, when it is identified that the application C being displayed on the display 231 is an application which is not supported by the first external electronic device 401 but is supported by the second external electronic device 1101, the processor 240 may output a first visual effect 1211 (for example, a shading effect) to a partial area of the popup window 1115 for displaying information 1117 related to the application A being output by the first external electronic device 401 and output a second visual effect 1213 (for example, a highlight effect) to another partial area of the popup window 1115 for displaying information 1119 related to the application B being output by the second external electronic device 1101 as indicated by reference numeral 1210.

For example, the first visual effect 1211 (for example, the shading effect) may be a visual effect indicating that the application C is an application which is not supported by the external electronic device 401. The second visual effect 1213 (for example, the highlight effect) may be a visual effect indicating that the application C is an application which is supported by the external electronic device 401.

The disclosure is not limited thereto, and the processor 240 may identify whether the application C is the application supported by the first external electronic device 401, based on that the drag & drop input 1111 and 1113 is detected in an area for displaying the information 1117 related to the application A in the popup window 1115. As described above, since the application C is the application which is not supported by the first external electronic device 401, the processor 240 may output an icon 1221 (for example, an icon “X”) indicating that the application C is the application which is not supported by the first external electronic device 401 as indicated by reference numeral 1220.

Referring to FIG. 12B, based on that the drag & drop input 1111 and 1113 is detected, the processor 240 may identify whether the application C being displayed on the display 231 is an application supported by the first external electronic device 401 and/or the second external electronic device 1101. When it is identified that the application C is an application which is supported by the first external electronic device 401 and the second external electronic device 1101, the processor 240 may output a second visual effect 1213 (for example, a highlight effect) to a partial area of the popup window 1115 for displaying the information 1117 related to the application A being output by the first external electronic device 401 and another partial area of the popup window 1115 for displaying the information 1119 related to the application B being output by the second external electronic device 1101 as indicated by reference numeral 1230.

The disclosure is not limited thereto, and the processor 240 may identify whether the application C is the application supported by the first external electronic device 401, based on that the drag & drop input 1111 and 1113 is detected in an area for displaying the information 1117 related to the application A in the popup window 1115. As described above, since the application C is the application supported by the first external electronic device 401, the processor 240 may output an item 1241 (for example, an icon “O”) indicating that the application C is the application supported by the first external electronic device 401 as indicated by reference numeral 1240.

Referring to FIG. 12C, the processor 240 may detect a user input 1251 and 1253 (for example, a drag & drop input or a swipe input) for moving from a partial area of the popup window 1115 for displaying the information 1117 related to the application A being output by the first external electronic device 401 to another partial area of the popup window 1115 for displaying the information 1119 related to the application B being output by the second external electronic device 1101. In this case, the processor 240 may receive information related to the application B from the second external electronic device 1101 and transmit the information to the first external electronic device 401. Further, the processor 240 may receive information related to the application A from the first external electronic device 401 and transmit the information to the second external electronic device 1101. The disclosure is not limited thereto, and the first external electronic device 401 and the second external electronic device 1101 may have the communication connection through a short-range communication circuit. In this case, the first external electronic device 401 and the second external electronic device 1101 may exchange the information related to the application A and the information related to the application B.

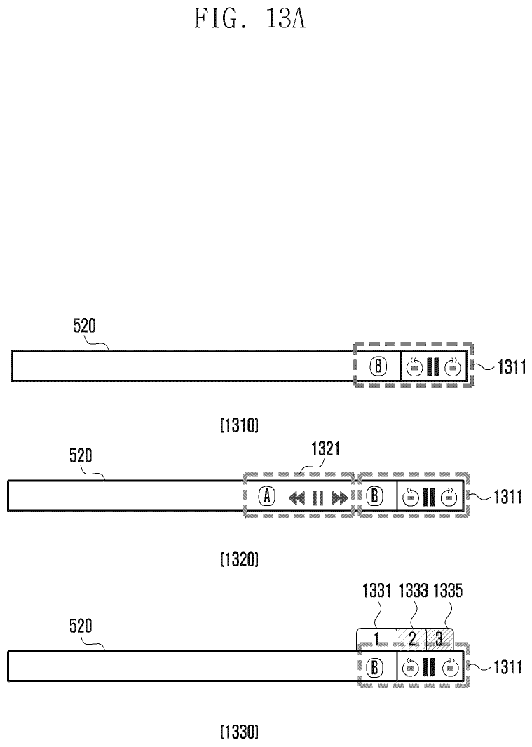

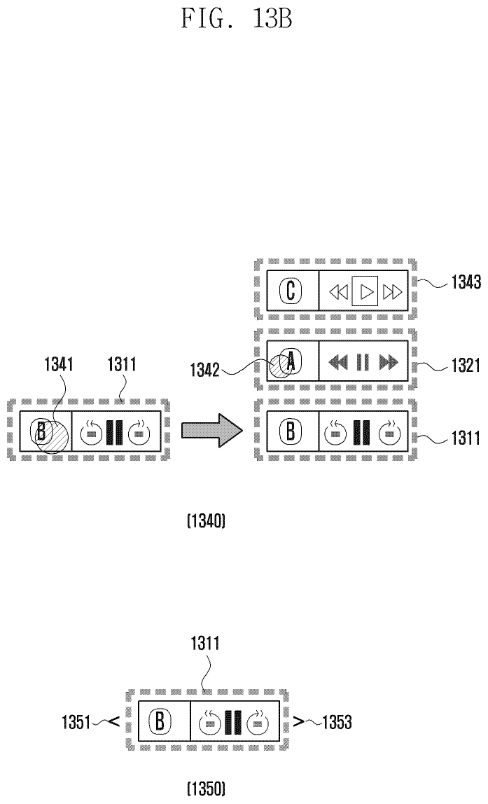

FIGS. 13A and 13B are diagrams illustrating a method of displaying at least one object indicating at least one application and at least one item for controlling at least one function of the application according to various embodiments of the disclosure.

Referring to FIGS. 13A and 13B, a processor (for example, the processor 240 of FIG. 2) of an electronic device (for example, the electronic device 201 of FIG. 2) may display an object indicating an application being executed in at least one external electronic device having a communication connection through a communication circuit (for example, the communication circuit 210 of FIG. 2) (for example, a short-range communication circuit) and at least one item for controlling at least one function of the application in the task bar area 520.

For example, when one external electronic device makes a communication connection with the electronic device 201, the processor 240 may display an object indicating an application B being executed in the external electronic device and at least one item 1311 for controlling at least one function of the application B in the task bar area 520 as indicated by reference numeral 1310.

In another example, when two external electronic devices make communication connections with the electronic device 201, the processor 240 may display an object indicating the application B being executed in the first external electronic device, at least one item 1311 for controlling at least one function of the application B, an object indicating the application A being executed in the second external electronic device, and at least one item 1321 for controlling at least one function of the application A in the task bar area 520 as indicated by reference numeral 1320.

In another example, when three external electronic devices make communication connections with the electronic device 201, the processor 240 may display an application being executed in each external electronic device and at least one item for controlling at least one function of the application in the task bar area 520 in a tab form as indicated by reference number 1330. For example, respective external electronic devices, for example, a first external electronic device, a second external electronic device, and a third external electronic device may be provided in tab forms 1311, 1333, and 1335. For example, when an input for selecting a first tab 1331 indicating the first external electronic device is detected, the processor 240 may display the object indicating the application B being executed in the first external electronic device and at least one item 1311 for controlling at least one function of the application B in the task bar area 520. In another example, when an input for selecting a second tab 1333 indicating the second external electronic device is detected, the processor 240 may display the object indicating the application A being executed in the second external electronic device and at least one item 1321 for controlling at least one function of the application A in the task bar area 520. In another example, when an input for selecting a third tab 1335 indicating the third external electronic device is detected, the processor 240 may display the object indicating the application C being executed in the third external electronic device and at least one item (not shown) for controlling at least one function of the application C in the task bar area 520.

In another example, referring to reference numeral 1340, in the state where the object indicating the application B being executed in the first external electronic device and at least one item 1311 for controlling at least one function of the application B are displayed in the task bar area 520, the processor 240 may detect a touch input 1341 for selecting the object indicating the application B. Based on that the touch input 1341 for selecting the object indicating the application B is detected, the processor 240 may display the object indicating the application A being executed in the second external electronic device and at least one item 1311 for controlling at least one function of the application A in the task bar area 520 instead of displaying the object indicating the application B and at least one item 1311 for controlling at least one function of the application B. In the state where the object indicating the application A being executed in the second external electronic device and at least one item 1321 for controlling at least one function of the application A are displayed in the task bar area 520, the processor 240 may detect a touch input 1342 for selecting the object indicating the application A. Based on that the touch input 1342 for selecting the object indicating the application A is detected, the processor 240 may display an object indicating an application C being executed in the third external electronic device and at least one item 1343 for controlling at least one function of the application C in the task bar area 520 instead of displaying the object indicating the application A and at least one item 1321 for controlling at least one function of the application A.

As indicated by reference numeral 1340 according to an embodiment of the disclosure, it has been described that the displaying of the object indicating the application being executed in another external electronic device and at least one item for controlling at least one function of the application is switched by the touch input for selecting the object indicating a specific application, but the disclosure is not limited thereto.

For example, the processor 240 may switch and display displaying of the object indicating the application executed in another external electronic device and at least one item for controlling at least one function of the application by a swipe input (for example, an up/down/left/right swipe input) detected on the object indicating the specific application displayed in task bar area 520 and/or at least one item for controlling at least one function of the application.

In another example, in the state where the object indicating the application B being executed in the first external electronic device and at least one item 1311 for controlling at least one function of the application B are displayed in the task bar area 520, the processor 240 may display a first indicator 1351 and a second indicator 1353 as indicated by reference numeral 1350. For example, when an input for selecting the first indicator 1351 is detected, the processor 240 may display the object indicating the application C being executed in the third external electronic device and at least one item 1343 for controlling at least one function of the application C in the task bar area 520 instead of displaying the object indicating the application B and at least one item 1311 for controlling at least one function of the application B. Alternatively, when an input for selecting the second indicator 1353 is detected, the processor 240 may display the object indicating the application A being executed in the second external electronic device and at least one item 1321 for controlling at least one function of the application A in the task bar area 520 instead of displaying the object indicating the application B and at least one item 1311 for controlling at least one function of the application B.

FIG. 14A illustrates a navigation area displayed in a task bar area according to an embodiment of the disclosure.

Referring to FIG. 14A, as indicated by reference numeral 1410 according to an embodiment of the disclosure, the task bar area 520 may display a navigation area 1411 together with the at least one object 525 (including a first object 525a and a second object 525b) indicating at least one application related to an electronic device (for example, the electronic device 201 of FIG. 2).

In an embodiment of the disclosure, the task bar area 520 and/or the navigation area 1411 may be displayed on the display 231 when a specific input is detected or according to a specific condition. The specific input according to an embodiment may include a swipe input (for example, a swipe input in an up direction from a bottom edge of the display 231). However, the disclosure is not limited thereto. The specific condition according to an embodiment may include a condition of detecting proximity of at least one external electronic device or a condition of making a communication connection with at least one external electronic device. However, the disclosure is not limited thereto.

In an embodiment of the disclosure, in the navigation area 1411, an item 1411a (for example, a menu button) for executing a menu, an item 1411b (for example, a home button) for moving to a home screen (for example, displaying a home screen), and/or an item 1411c for returning back to and displaying a previous screen (for example, a back button). However, the disclosure is not limited thereto.

In an embodiment of the disclosure, a processor (for example, the processor 240 of FIG. 2) may detect execution of a specific application while the home screen and the navigation area 1411 are displayed in the task bar area 520. Based on that execution of the specific application is detected, the processor 240 may adjust and display the task bar area 520 (for example, adjust the task bar area 520 to be smaller than a predetermined size) so that an area of the display 231 for displaying an execution screen of the specific application can be wider. For example, when execution of the specific application is detected in the state where the task bar area 520 is displayed with a first length from a bottom edge of the display 231, the processor 240 may control the task bar area 520 to be displayed with a second length (for example, the second length being shorter than the first length) from the bottom edge of the display 231. In this case, the processor 240 may perform control to adjust and display the at least one object 525 being displayed in the task bar area 520, the navigation area 1411, and at least one item 1411a, 1411b, and 1411c (for example, adjust the items to be smaller than a preset size) being displayed in navigation area 1411.

In an embodiment of the disclosure, when the communication connection with at least one external electronic device is made, as indicated by reference numeral 1420, the processor 240 may display the at least one object 525 indicating at least one application related to the electronic device 201, the navigation area 1411, an object 1421 indicating an application which can be executed in the external electronic device, and/or an item 1423 for controlling functions of the application 1422 being executed in the external electronic device in the task bar area 520.

As indicated by reference numerals 1410 and 1420 according to an embodiment of the disclosure, it has been described that the navigation area 1411 is displayed in the task bar area 520 but is not limited thereto. For example, the navigation area 1411 may be displayed to be adjacent to the task bar area 520. For example, as indicated by reference numerals 1430 and 1440, the navigation area 1411 may be displayed in a lower area of the task bar area 520 (for example, between the task bar area 520 and the bottom edge of the display (for example, the display 231 of FIG. 2)). In another example, as indicated by reference numerals 1450 and 1460, the navigation area 1411 may be displayed in an upper area of the task bar area 520.

In an embodiment of the disclosure, when the communication connection with at least one external electronic device is made in the state (for example, the state of reference numeral 1430) where the navigation area 1411 is displayed in a lower area of the task bar area 520 (for example, the task bar area 520 and the display (for example, the display 231 of FIG. 2)), the processor 240 may further display the object 1421 indicating the application which can be executed in the external electronic device and/or the item 1423 for controlling functions of the application 1422 being executed in the external electronic device in the task bar area 520 as indicated by reference numeral 1440.

In an embodiment of the disclosure, when the communication connection with at least one external electronic device is made in the state (for example, the state of reference numeral 1450) where the navigation area 1411 is displayed in an upper area of the task bar area 520, the processor 240 may further display the object 1421 indicating the application which can be executed in the external electronic device and/or the item 1423 for controlling functions of the application 1422 being executed in the external electronic device in the task bar area 520 as indicated by reference numeral 1460.

In an embodiment of the disclosure, as illustrated in the home screen and as indicated by reference numeral 1430, 1440, 1450, or 1460, the processor 240 may detect execution of a specific application while the navigation area 1411 is displayed in an area adjacent to the task bar area 520 (for example, an upper area of the task bar area 520 or a lower area of the task bar area 520). Based on that execution of the specific application is detected, the processor 240 may display the navigation area 1411 in the task bar area 520 as indicated by reference numeral 1410 or 1420 so that an area of the display 231 for displaying an execution screen of the specific application can be wider. Further, the processor 240 may display the at least one object 525 indicating at least one application displayed in the task bar area 520 to be smaller than a preset size in the task bar area 520.

The disclosure is not limited thereto, and, for example, when a specific application is executed, the processor 240 may maintain the state where the navigation area 1411 is displayed to be adjacent to the task bar area 520 (for example, a lower area or an upper area of the task bar area 520) as indicated by reference numeral 1430 (or 1440) and reference numeral 1450 (or 1460). In this case, the processor 240 may control the task bar area 520, the at least one object 525 being displayed in the task bar area 520, the navigation area 1411, and at least one item 1411a, 1411b, and 1411c being displayed within the navigation area 1411 to be displayed in size smaller than a preset size.

In another example, when the specific application is executed, the processor 240 may display only the navigation area 1411 in the task bar area 520 without displaying the at least one object 525 indicating at least one application.

FIG. 14B illustrates common controller items according to an embodiment of the disclosure.

In an embodiment of the disclosure, based on that a communication connection with the external electronic device is made, a processor (for example, the processor 240 of FIG. 2) may display the at least one object 525 indicating at least one application related to the electronic device 201 and/or at least one object 1471 and 1473 indicating at least one application (for example, the application I and/or the application J) which can be executed in the external electronic device in the task bar area 520.

Referring to FIG. 14A, it is assumed and described that the external electronic device executes the application J as the object 1473 indicating the application J is selected from among at least one object 1471 and 1473 indicating at least one application (for example, the application I and/or the application J) which can be executed in the external electronic device.

In an embodiment of the disclosure, the object 1473 indicating the application J being executed (or output) by the external electronic device among at least one object 1471 and 1473 indicating at least one application (for example, the application I and/or the application J) may be displayed differently from the object 1471 indicating the application I which is not being executed by the external electronic device. For example, the processor 240 may apply a visual effect to the object 1473 indicating the application J being executed (or output) by the external electronic device and display the object. For example, the visual effect may include a visual effect of displaying the outline of an object in bold, a visual effect of displaying an object with hatching, and/or a visual object of displaying an object in a specific color. However, the disclosure is not limited thereto.

In an embodiment of the disclosure, control information for controlling the application J being executed (or output) by the external electronic device may not be transmitted to the external electronic device, or control information for controlling the application J being executed (or output) by the external electronic device may not be identified. In this case, the processor 240 may display the object 1471 indicating the application I which can be executed in the external electronic device and the object 1473 indicating the application J being executed in the external electronic device as indicated by reference numeral 1470. In other words, the processor 240 may not display an item (for example, the item 1423 of FIG. 14A) for controlling functions of the application J being executed in the external electronic device.

In this case, the processor 240 may provide common controller functions corresponding to functions which can be commonly used by applications, based on a gesture detected on the object 1473 indicating the application J. For example, the common controller functions may include the functions displayed in the navigation area (for example, the function of executing a menu, the function of moving to a home screen, and/or the function of displaying a previous screen) described with reference to FIG. 14A, a function of re-executing a recently executed function, and/or a function of scrolling a screen of an application being displayed in the external electronic device. However, the disclosure is not limited thereto.

In an embodiment of the disclosure, a gesture corresponding each of the common controller functions may be mapped, and the processor 240 may allow the external electronic device to perform a function corresponding to the gesture, based on the gesture detected on the object 1473 indicating the application J. In an embodiment of the disclosure, the gesture may include a swipe gesture (for example, an up and down swipe gesture or a left and right swipe gesture) on the object 1473 indicating the application J.

The disclosure is not limited thereto, and the processor 240 may display a list of the common controller functions, based on the gesture detected on the object 1473 indicating the application J. When a specific controller function is selected from the list, the processor 240 may allow the external electronic device to perform a function corresponding to the gesture.

The disclosure is not limited thereto, and, for example, the processor 240 may further display a gesture area 1481 to be adjacent to the object 1473 indicating the application J being executed (or output) by the external electronic device in the task bar area 520 as indicated by reference numeral 1480. The processor 240 may allow the external electronic device to perform a function corresponding to the gesture, based on the swipe gesture (for example, the up and down swipe gesture or the left and right swipe gesture) detected in the gesture area 1481.

In another example, the processor 240 may display items (for example, an item 1491 indicating a function of executing a menu and/or an item 1492 indicating a function of returning back to a previous screen) indicating common controller functions to be adjacent to the object 1473 indicating the application J as indicated by reference numeral 1490. Although not illustrated, the items indicating the common controller functions adjacent to the object 1473 may further include an item indicating a function of moving to a home screen, an item indicating a function of re-executing a recently executed function, and/or an item indicating a function of scrolling a screen of an application being displayed in the external electronic device.

Referring to FIG. 14B, it has been described that, when control information for controlling the application J being executed (or output) by the external electronic device is not be received from the external electronic device or control information for controlling the application J being executed (or output) by the external electronic device is not identified, the common controller functions are provided based on the gesture detected on the object 1473, the gesture area 1481, and/or the items indicating the common controller items, but are not limited thereto. Even when there is control information for controlling the application J being executed (or output) by the external electronic device (for example, when control information for controlling the application J being executed (or output) by the external electronic device is received from the external electronic device or when control information for controlling the application J is identified), the processor 240 may provide common controller functions for controlling the application J, based on the gesture detected on the object 1473. Further, the processor 240 may further display the gesture area 1481 or items indicating common controller functions along with at least one item for controlling at least one function of the application J being executed in the external electronic device. In this case, the processor 240 may provide common controller functions for controlling the application, based on the gesture detected in the gesture area 1481 or on items indicating common controller functions.

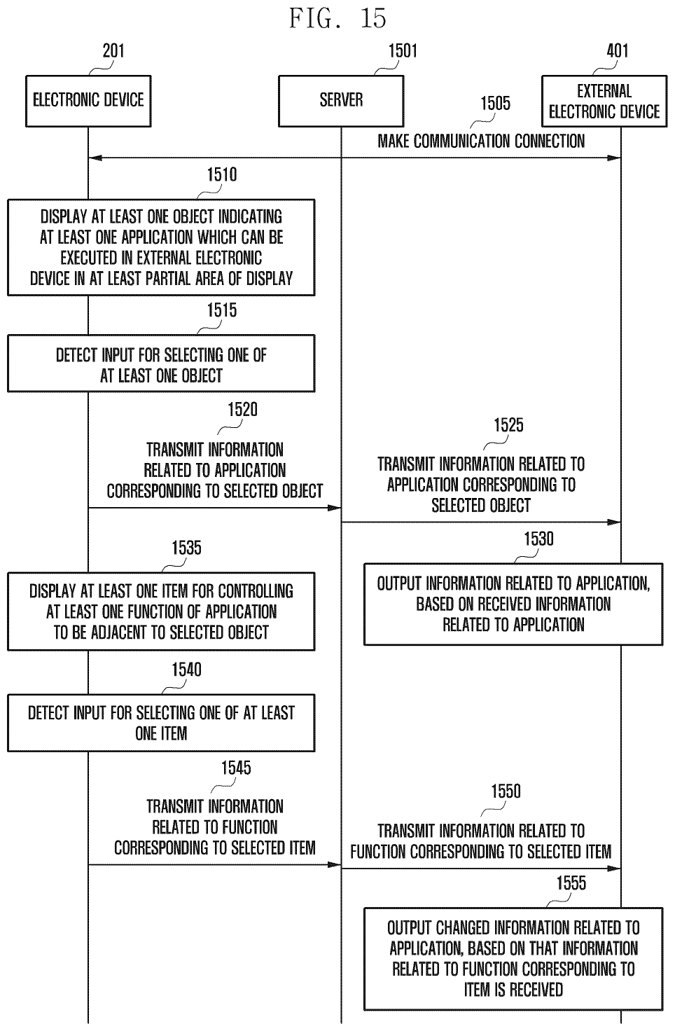

FIG. 15 illustrates a flow of signals between an electronic device, a server, and an external electronic device according to an embodiment of the disclosure.

In the following embodiments of the disclosure, respective operations may be sequentially performed but the sequential performance is not necessary. For example, orders of the operations may be changed, and at least two operations may be performed in parallel.

FIG. 15 according to various embodiments is a diagram illustrating an embodiment in which the electronic device 201 transmits information related to the application corresponding to the selected object and information related to the function corresponding to the selected item to the external electronic device 401 through the server 1501, compared to FIG. 4 described above.

Since operations illustrated in FIG. 15 according to various embodiments are similar to the operations of FIG. 4 except that the information is transmitted through the server 1501, description related thereto may be replaced with the description of FIG. 4.

Referring to FIG. 15, the electronic device 201 may make a communication connection with the external electronic device 401 in operation 1505. For example, the electronic device 201 may make a communication connection with the external electronic device 401 in proximity to the electronic device 201 through communication (for example, the communication circuit 210 of FIG. 2) (for example, short-range wireless communication, such as UWB, Bluetooth, or Bluetooth low energy).

In an embodiment of the disclosure, the electronic device 201 may display at least one object indicating at least one application which can be executed by the external electronic device 401 in at least a partial area (for example, a task bar area) of a display (for example, the display 231 of FIG. 2) in operation 1510.

In an embodiment of the disclosure, at least one object indicating at least one application which can be executed in the external electronic device 401 may include at least one object indicating at least one application (for example, at least one application being displayed on the display (for example, the display 231 of FIG. 2) and/or at least one application being executed in the background) being executed in the electronic device 201, an object indicating an application which has been most frequently executed in the electronic device 201, at least one object indicating at least one application which has been executed in the electronic device 201 a predetermined number of times or more, and/or at least one object indicating at least one application configured as applications frequently used by the user of the electronic device 201. However, the disclosure is not limited thereto, and at least one object indicating at least one application may include at least one object indicating at least one application which has been executed in the external electronic device 401 a predetermined number of times or more and/or an object indicating an application which has been most frequently executed in the external electronic device 401.

In an embodiment of the disclosure, the electronic device 201 may detect an input for selecting one of the at least one object in operation 1515. The electronic device 201 may transmit information related to the application corresponding to the selected object to the server 1501 in operation 1520. For example, the information related to the application corresponding to the selected object may include identification information for identifying the application, login information (for example, account information) of the application, and/or information related to execution of the application. For example, when the application is an application related to multimedia content, the information related to execution of the application may include information on the reproduction time of the multimedia content. When the application is a browser application, the information related to execution of the application may be link information. However, the disclosure is not limited thereto.

In an embodiment of the disclosure, the server 1501 may transmit the information related to the application corresponding to the selected object received from the electronic device 201 to the external electronic device 401 in operation 1525.

In an embodiment of the disclosure, the external electronic device 401 may output the information related to the application, based on the information related to the application received from the server 1501 in operation 1530. For example, when the application is an application related to multimedia content, the external electronic device 401 may output the multimedia content from reproduction time information, based on information related to execution of the application received from the server 1501, for example, reproduction time information of the multimedia content.

In an embodiment of the disclosure, when the multimedia content is being output to a display (for example, the display 231 of FIG. 2) of the electronic device 201 and the external electronic device 401 outputs information related to the application, based on the information related to the application received from the server 1501, the multimedia content may not be displayed on the display 231 of the electronic device 201. However, the disclosure is not limited thereto.

In an embodiment of the disclosure, the electronic device 201 may display at least one item for controlling at least one function of the application to be adjacent to the selected object in operation 1535. For example, when the application is an application related to multimedia content, at least one function of the application may include a function for controlling reproduction of the multimedia content (for example, pause, play, forward, and/or backward). In another example, when the application is an application related to a user interface, at least one function of the application may include a function for controlling the user interface (for example, forward, backward, and/or home). In another example, when the application is a photo application, at least one function of the application may include a function of displaying a previous photo, a function of displaying a next photo, and/or a function of displaying a recommended photo. However, the disclosure is not limited thereto.

In an embodiment of the disclosure, the electronic device 201 may detect an input for selecting one of the at least one item in operation 1540. The electronic device 201 may transmit information related to the function corresponding to the selected item to the server 1501 in operation 1545.

In an embodiment of the disclosure, the server 1502 may transmit the information related to the function corresponding to the selected item received from the electronic device 201 to the external electronic device 401 in operation 1550. The external electronic device 401 may output changed application information, based on the information related to the function corresponding to the selected item received from the server 1502 in operation 1555.

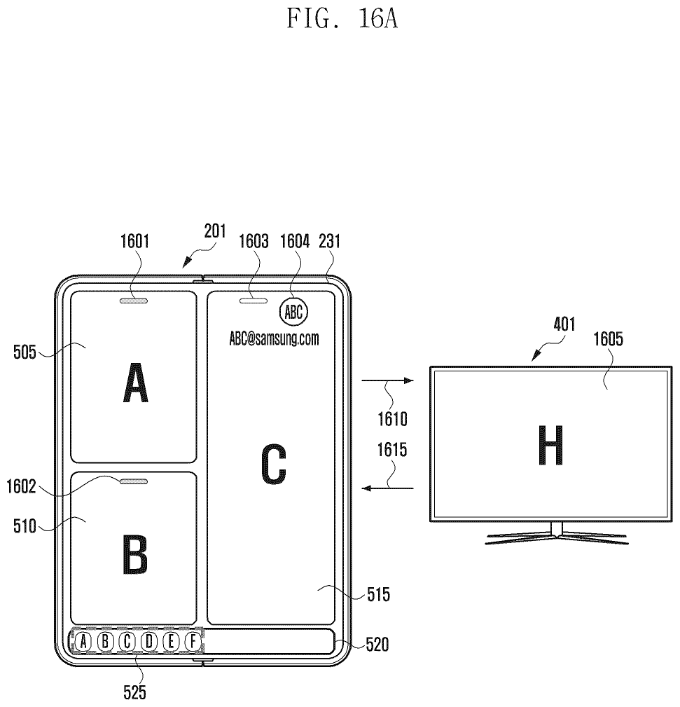

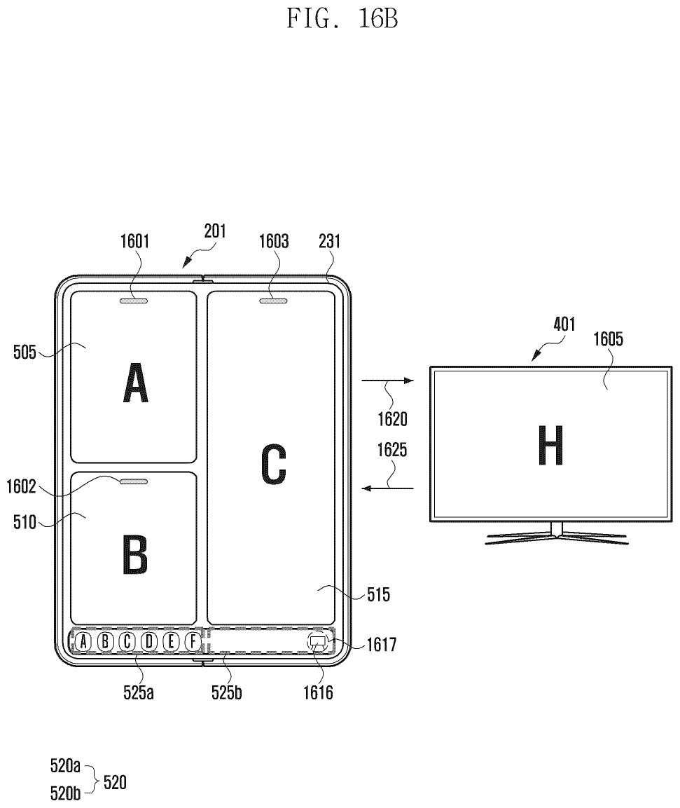

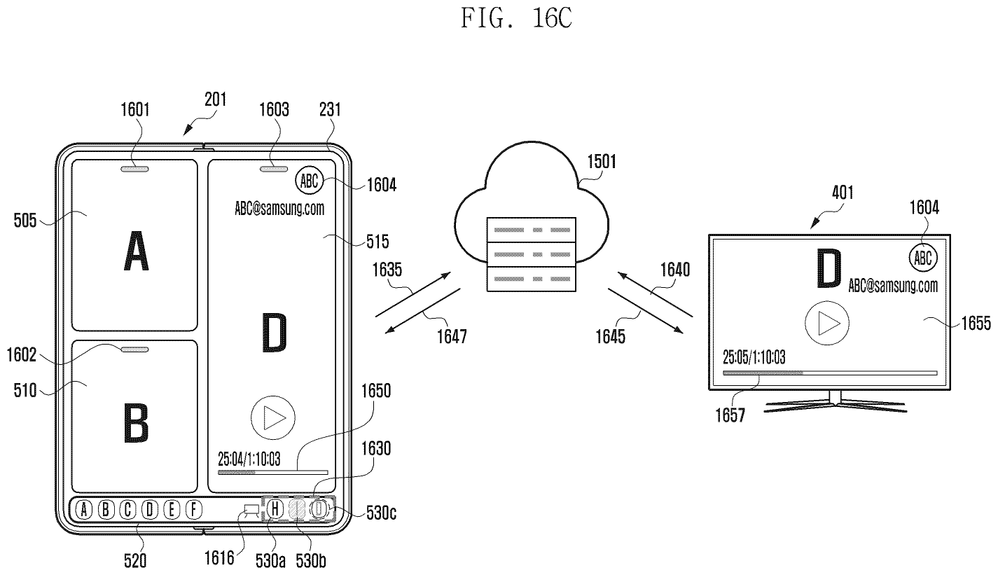

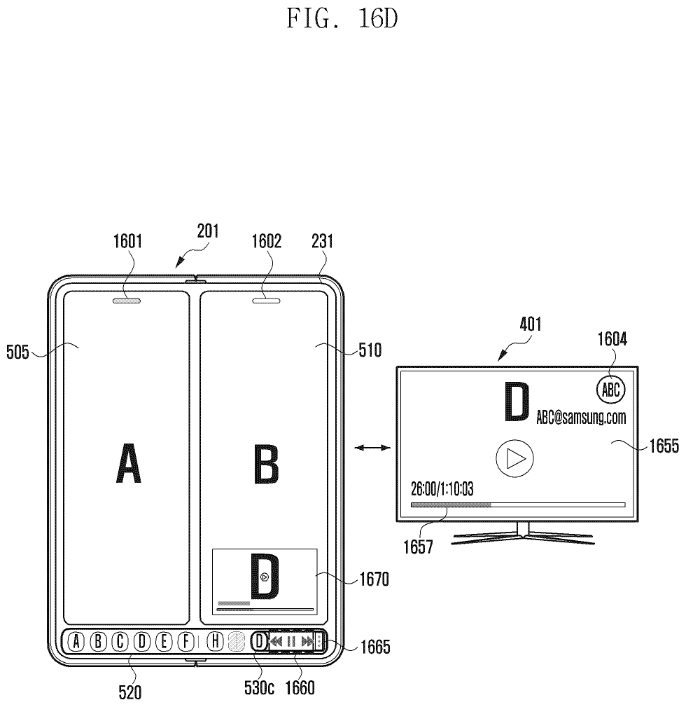

FIGS. 16A, 16B, 16C, and 16D are diagrams illustrating a method by which an electronic device controls an external electronic device according to various embodiments of the disclosure.

Referring to FIG. 16A, as a plurality of applications (for example, an application A, an application B, and an application D) is executed, a processor (for example, the processor 240 of FIG. 2) of an electronic device (for example, the electronic device 201 of FIG. 2) may display screens of the plurality of applications (for example, the application A, the application B, and the application D) (for example, a first screen 505 of the application A, the second screen 510 of the application B, and the third screen 515 of the application D) on a display (for example, the display 231 of FIG. 2) (for example, in a multi-window form). For example, the processor 240 may split the entire area of the display 231 into three areas and display the first screen 505 of the application A, the second screen 510 of the application B, and the third screen 515 of the application D in the split areas, respectively.

In an embodiment of the disclosure, windows displaying the first screen 505 of the application A, the second screen 510 of the application B, and the third screen 515 of the application D may include window handles 1601, 1602, and 1603. Among multiple windows, the handle 1603 of the activated window (for example, the window displaying the third screen 515 of the application D) may have the form (for example, distinguished color, shade, and/or shape) distinguished from the deactivated window handle (for example, the 1601 of the window displaying the first screen 505 of the application A or the handle 1602 of the window displaying the second screen 510 of the application B).

When it is assumed and described that the third screen 515 of the application D according to an embodiment is a screen for reproducing multimedia content, the processor 240 may output a reproduction screen of the multimedia content, based on a user account which logs in a server related to the application D through the window displaying the third screen 515 of the application D. In this case, in one area of the window (for example, an upper area of the window) displaying the third screen 515 of the application D, user account information 1604 used to log in the server may be displayed. The disclosure it not limited thereto, and a progress bar 1657 including a current reproduction time point of the multimedia content may be further displayed in the window displaying the third screen 515 of the application D (see FIG. 16C).

In an embodiment of the disclosure, the processor 240 may display the at least one object 525 indicating at least one application (for example, the application A, the application B, the application C, the application D, the application E, and/or the application F) related to the electronic device 201 in the task bar area 520 of the display 231. For example, the at least one object 525 indicating at least one application related to the electronic device 201 may include at least one object indicating at least one application (for example, at least one application being displayed on the display 231 and/or at least one application being executed in the background) being executed in the electronic device 201, an object indicating an application which has been most frequently executed in the electronic device 201, at least one object indicating at least one application which has been executed in the electronic device 201 a predetermined number of times or more, and/or at least one object indicating at least one application configured as applications frequently used by the user of the electronic device 201.

In an embodiment of the disclosure, a fourth screen 1605 of the application H may be being displayed on a display (not shown) of the external electronic device 401. In the following embodiments of the disclosure, it is assumed that the external electronic device 401 is a smart TV.

In an embodiment of the disclosure, the processor 240 may perform a BLE scan operation according to a predetermined cycle (for example, about 3 to 5 minutes) in order to check the connectable external electronic device 401 (for example, the smart TV) as indicated by reference numeral 1610. The external electronic device 401 may broadcast a signal including user account information and/or identification (ID) information of the external electronic device 401 as indicated by reference numeral 1615.

In an embodiment of the disclosure, the processor 240 may compare the user account information and/or the ID information of the external electronic device 401 received from the external electronic device 401 with ID information of the external electronic device 401 included within the same user account information stored in memory (for example, the memory 220 of FIG. 2) and identify the external electronic device 401 as the connectable external electronic device 401.

Referring to FIG. 16B, the processor 240 may display an object 116 indicating the external electronic device 401 in the task bar area 520, based on that the connectable external electronic device 401 is identified.

In an embodiment of the disclosure, the task bar area 520 may include a first area 520a related to the electronic device 201 and a second area 520b related to the external electronic device 401. For example, in the first area 520a of the task bar area 520, at least one application related to the electronic device 201 may be displayed. In the second area 520b of the task bar area 520, objects related to the external electronic device 401 (for example, an object indicating the external electronic device 401, an object indicating an application which can be executed in the external electronic device, and/or an item for controlling functions of an application being executed in the external electronic device 401) may be displayed.

In an embodiment of the disclosure, the processor 240 may make a BLE communication connection (for example, BLE connection establishment) with the external electronic device 401, based on a user input 1617 for the object 1616 related to the external electronic device 401. For example, the processor 240 may transmit a request signal for the BLE connection including information related to the electronic device 201 (for example, information on the electronic device 201, OS compatibility information, or application compatibility information) to the external electronic device 401 as indicated by reference numeral 1620. In response to the request signal for the BLE connection received from the electronic device 201, the external electronic device 401 may transmit a response signal including information related to the external electronic device 401 (for example, information on the external electronic device 401 (for example, information indicating whether visual information (display information) and/or auditory information (audio information) are output) and a list of compatible applications) to the electronic device 201 as indicated by reference numeral 1625.

In an embodiment of the disclosure, based on the response signal received from the external electronic device 401 and establishment of the communication connection with the external electronic device 402, the processor 240 may display the object (for example, the object 530a indicating the application H, the object 530b indicting the application I, and/or the object 530c indicating the application D) which can be executed in the external electronic device 401 in the task bar area 520 as illustrated in FIG. 16C. In an embodiment of the disclosure, the object (for example, the object 530a indicating the application H, the object 530b indicting the application I, and/or the object 530c indicating the application D) indicating at least one application which can be executed in the external electronic device 401 may be displayed to be adjacent to the object 1616 indicating the external electronic device 401.

In an embodiment of the disclosure, the object indicating at least one application which is displayed in task bar area 520 and can be executed in the external electronic device 401 may display information indicating whether at least one application which can be executed in the external electronic device 401 is installed in the electronic device 201. For example, among the object 530a indicating the application H, the object 530b indicting the application I, and/or the object 530c indicating the application D which can be executed in the external electronic device 401, an object indicating an application which is not installed in the electronic device 201 may be displayed to be distinguished from objects indicating applications installed in the electronic device 201.

For example, when it is assumed and described that the application which is not installed in the electronic device 201 is the application I, the processor 240 may apply a visual effect, which is different from a visual effect applied to the object 530a indicating the application H and the object 530c of the application D installed in the electronic device 201, to the object 530b indicating the application I which is not installed in the electronic device 201. For example, the processor 240 may display the object 530b indicating the application I as a dummy. When an input for selecting the object 530b indicating the application I displayed as the dummy is detected, the processor 240 may install the application I.

In an embodiment of the disclosure, the processor 240 may receive (or detect) a user input 1630 for selecting the object 530c indicating the application D. Based on the user input 1630, the processor 240 may transmit information related to the application D and/or execution information (for example, application ID information, application account information, and/or reproduction information (play information)) to the server 1501 (for example, a cloud server) as indicated by reference numeral 1635. Based on that a response signal is received from the server 1501 as indicated by reference numeral 1647, the processor 240 may identify that the server 1501 receives information related to the application D and/or execution information (for example, application ID information, application account information, and/or reproduction information (play information)).

In an embodiment of the disclosure, the server 1501 may transmit the information related to the application D and/or the execution information (for example, the application ID information, the application account information, and/or the play information) 1650 received from the electronic device 101 to the external electronic device 401 as indicated by reference numeral 1645. Based on that a response signal is received from the external electronic device 401 as indicated by reference numeral 1640, the server 1501 may identify that the external electronic device 401 receives the information related to the application D and/or the execution information (for example, the application ID information, the application account information, and/or the play information).

In an embodiment of the disclosure, based on that the information related to the application D and/or the execution information (for example, the application ID information, the application account information, and/or the play information) is received from the server 1501, the external electronic device 401 may end the application H being executed and execute the application D, based on the information related to the application D received from the server 1501, for example, the application ID information and/or the application account information according to the same user account 1604. The external electronic device 401 may display a reproduction screen 1655 of content including a process bar 1657 including a reproduction time point, based on play information related to the application D.

In an embodiment of the disclosure, the processor 240 may end displaying of the third screen 515 of the application D, based on that the information related to the application D and/or the execution information (for example, the application ID information, the application account information, and/or the play information) is transmitted to the server 1501 (for example, the cloud server) as indicated by reference numeral 1635.

In an embodiment of the disclosure, the processor 240 may reconfigure and display the first screen 505 of the application A and the second screen 510 of the application B as multiple windows as illustrated in FIG. 16D. For example, the processor 240 may activate one of the windows displaying the first screen 505 of the application A and the second screen 510 of the application B, based on the priority. For example, the priority may be configured based on a most recently executed application or an application which has been executed more than a predetermined number of times. However, the disclosure is not limited thereto.

In an embodiment of the disclosure, the processor 240 may display a controller 1660 for controlling at least one function for the application D being executed by the external electronic device 401 in the task bar area 520. For example, the processor 240 may display the controller 1660 for controlling at least one function for the application D to be adjacent to the object 530c indicating the application D in the task bar area 520. When an input for selecting the controller 1660 is received, the processor 240 may display a popup window 1670 (for example, a preview screen including a current reproduction time (for example, a progress bar) for the reproduction screen 1655 of content of the application D being output by the external electronic device 401 to be adjacent to the object 530c indicating the application D.

In an embodiment of the disclosure, the processor 240 may further display another visual object 1665 for controlling at least one function for the application D being executed by the external electronic device 401 in the task bar area 520. For example, the other visual object 1665 may include an object for changing an aspect ratio (for example, for changing a ratio of the screen of the application D being executed by the external electronic device 401), an object for displaying a floating icon (for example, providing a controller for controlling at least one function for the application D included in the task bar area 520 as a floating icon), and/or an object for ending the executing and the connection (for example, for ending the application D being executed by the external electronic device 401 and/or ending the communication connection with the external electronic device 401). However, the disclosure is not limited thereto.

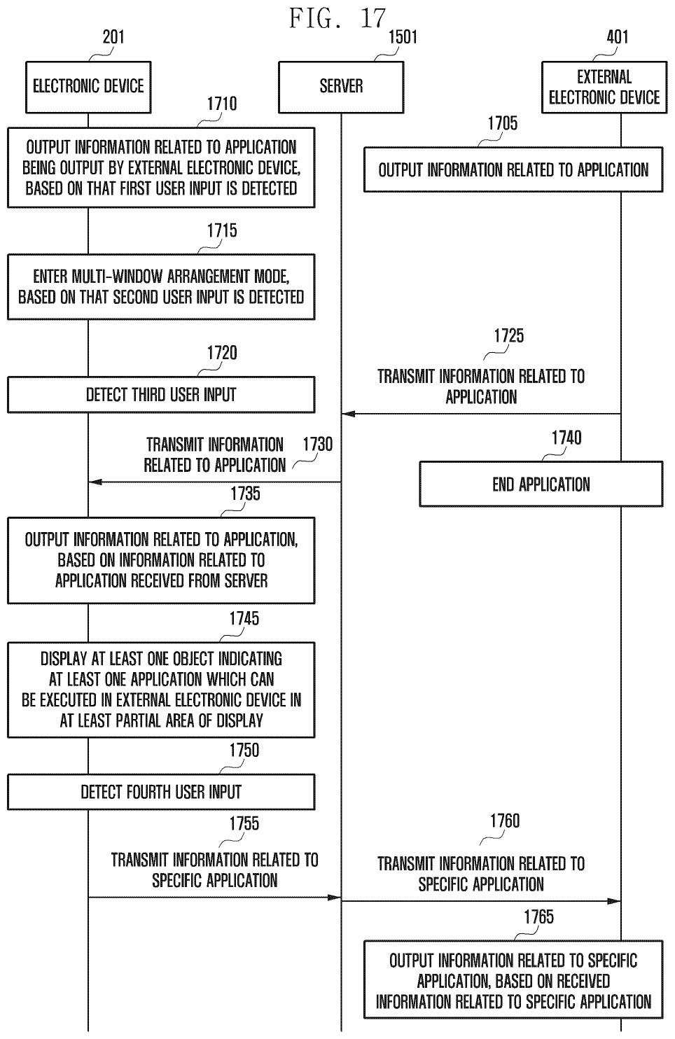

FIG. 17 illustrates a flow of signals between an electronic device, a server, and an external electronic device according to an embodiment of the disclosure.

In the following embodiments of the disclosure, respective operations may be sequentially performed but the sequential performance is not necessary. For example, orders of the operations may be changed, and at least two operations may be performed in parallel.

Since operations illustrated in FIG. 17 according to various embodiments are similar to the operations of FIGS. 7A and 7B described above except that the external electronic device 401 transmits the information related to the application and the information related to the specific application to the electronic device 201 through the server 1501, description related thereto can be replaced with the description of FIGS. 7A and 7B.

Referring to FIG. 17, the external electronic device 401 may be outputting information of an application in operation 1705.

In an embodiment of the disclosure, the electronic device 201 may display information related to the application being output by the external electronic device 401, based on that a first user input is detected in operation 1710. For example, the electronic device 201 may detect the first user input (for example, a long press input) on at least one item for controlling at least one function of the application being output by the external electronic device 401 displayed in the task bar area 520. When the first user input is detected, the electronic device 201 may display, through a popup window, information related to the application being output by the external electronic device 401 to be adjacent to at least one item on which the first user input has been detected.

In an embodiment of the disclosure, the electronic device 201 may enter a multi-window arrangement mode, based on that a second user input (for example, a long press input) is detected in operation 1715. For example, the electronic device 201 may detect the second user input in the popup window for information related to the application being output by the external electronic device 401. The electronic device 201 may detect a third user input in operation 1720. For example, the electronic device 201 may detect the third user input (for example, a drag & drop input) for moving from a popup window for information related to the application being output by the external electronic device 401 to a specific area of the display 231.

In an embodiment of the disclosure, although not illustrated, a signal making a request for information related to the application being executed in the external electronic device 401 may be transmitted to the external electronic device 401 through the server 1501, based on that the third user input is detected. The external electronic device 401 may transmit the information related to the application to the server 1501, based on that the signal making the request for the information related to the application being executed in the external electronic device 401 is received in operation 1725. For example, the information related to the application may include identification information for identifying the application, login information (for example, account information) of the application, and/or information related to execution of the application.

In an embodiment of the disclosure, the server 1501 may transmit the information related to the application received from the external electronic device 401 to the electronic device 201 in operation 1730. The electronic device 201 may output the information related to the application, based on the information related to the application received from the server 1501 in operation 1735. For example, the electronic device 201 may output visual information (for example, a screen) of the application to the display 231 and/or display auditory information (for example, an audio signal) of the application through an audio output circuit.

In an embodiment of the disclosure, the external electronic device 401 may end the application in operation 1740.

In an embodiment of the disclosure, the electronic device 201 may display at least one object indicating at least one application which can be executed in the external electronic device 401 in at least a partial area (for example, the task bar area 520) of the display 231 in operation 1745. The electronic device 201 may detect a fourth user input in operation 1750. For example, the electronic device 201 may detect a fourth user input (for example, a drag & drop input) for moving from a screen of a specific application being displayed on the display 231 to a popup window for information related to the application being output by the external electronic device 401. Based on that the fourth user input is detected, the electronic device 201 may transmit information related to the specific application to the server 1501 in operation 1755.

In an embodiment of the disclosure, the server 1501 may transmit the information related to the specific application to the external electronic device 401 in operation 1760. The external electronic device 401 may output the information related to the specific application, based on the information related to the specific application received from the electronic device 201 in operation 1765. For example, when the external electronic device 401 includes a display and an audio output circuit, the external electronic device 401 may output information related to the specific application, for example, visual information and/or auditory information, based on the information related to the specific application. In another example, when the external electronic device 401 includes only an audio output circuit without a display, the external electronic device 401 may output the information related to the specific application, for example, auditory information, based on the information related to the specific application.

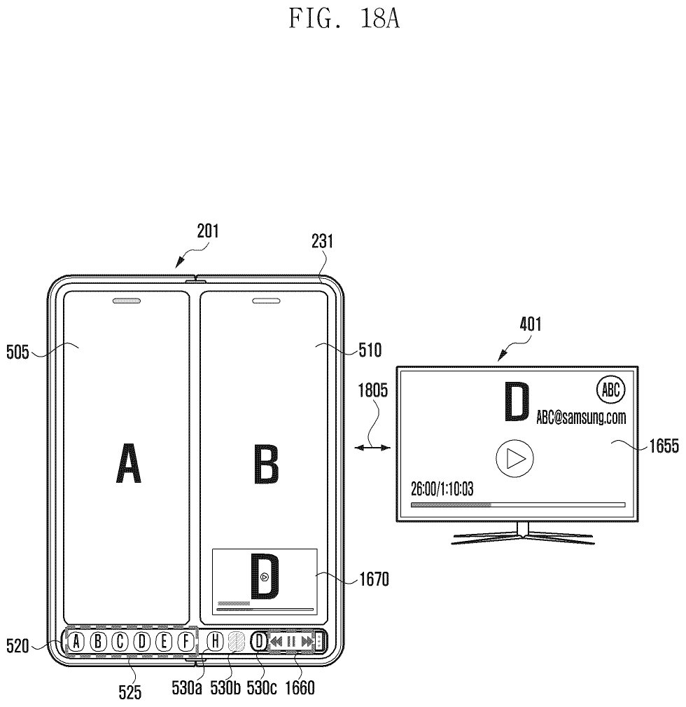

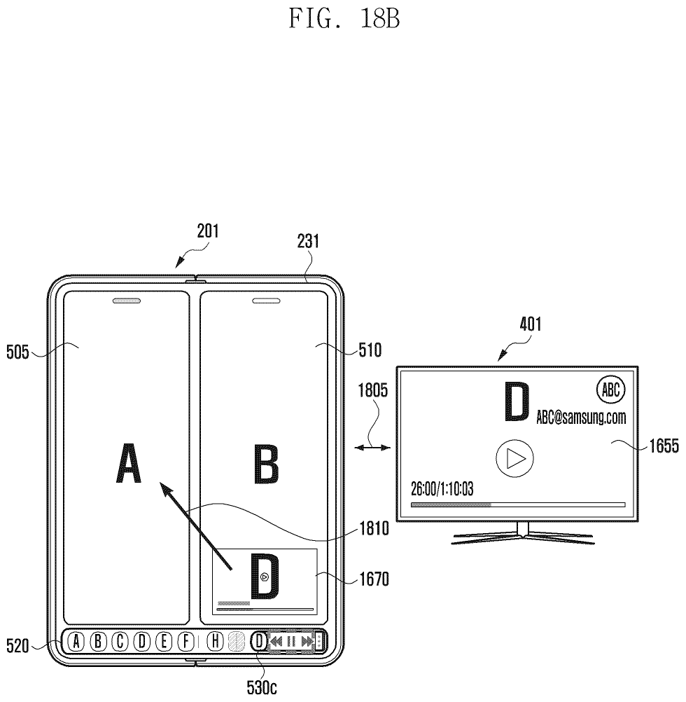

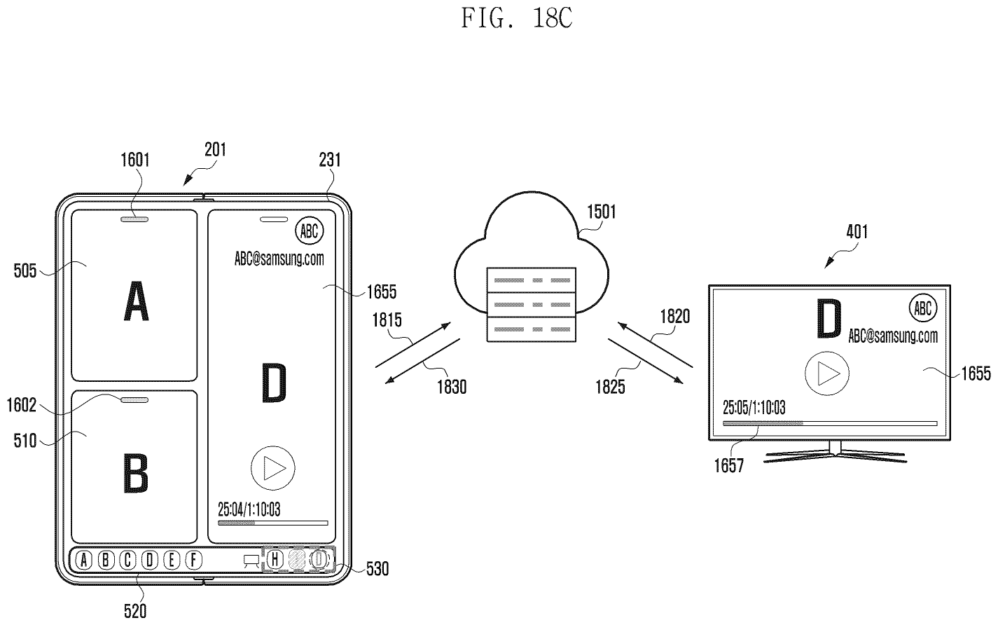

FIGS. 18A, 18B, and 18C are diagrams illustrating a method by an electronic device controls an external electronic device according to various embodiments of the disclosure.

Referring to FIG. 18A, a processor (for example, the processor 240 of FIG. 2) of an electronic device (for example, the electronic device 201 of FIG. 2) may display the first screen 505 of the application A and the second screen 510 of the application B on a display (for example, the display 231 of FIG. 2A) in a multi-window form.

Referring to FIG. 16D, the external electronic device 401 may make a communication connection 1805 with the electronic device 201 and may be outputting information (for example, visual information and/or auditory information) related to the application D, based on the information related to the application D received through the server 1501.

In an embodiment of the disclosure, the processor 240 may display the at least one object 525 indicating at least one application being executed in the electronic device 201, at least one object (for example, the object 530a indicating the application H and the object 530b indicating the application I) indicating at least one application which can be executed in the external electronic device 401, the object 530c indicating the application D being executed in the external electronic device 401, and/or the controller 1660 for controlling at least one function of the application D in the task bar area 520.

In an embodiment of the disclosure, the processor 240 may detect a first user input on the controller 1660 for controlling at least one function of the application D being executed in the external electronic device 401. For example, the first user input may include a long press input. However, the disclosure is not limited thereto.

In an embodiment of the disclosure, based on that the first user input is detected, the processor 240 may display information (for example, a preview screen including a current reproduction time point (for example, a progress bar)) related to the application D being output by the external electronic device 401 to be adjacent to the object 530c indicating the application D through the popup window 1670.

Referring to FIG. 18B, the processor 240 may detect a second user input 1810. For example, the second user input 1810 may include a drag & drop input for moving and dropping the popup window 1670 to a specific area of the display 231 in the state where the popup window 1670 for the information related to the application D being output by the external electronic device 401 is selected.

Referring to FIG. 18C, based on that the second user input 1810 for moving the popup window 1670 to the specific area of the display 231 is detected in the state where the popup window 1670 is selected, the processor 240 may make a request for the information related to the application D being executed in the external electronic device 401 to the server 1501 as indicated by reference numeral 1815. The server 1501 may make a request for the information related to the application D being executed in the external electronic device 401 as indicated by reference numeral 1825. The external electronic device 401 may transmit the information related to the application D being executed to the server 1501 as indicated by reference numeral 1820. For example, the information related to the application D may include identification information for identifying the application D, login information (for example, account information) of the application D, and/or information related to execution of the application.

In an embodiment of the disclosure, the server 1501 may transmit the information related to the application D received from the external electronic device 401 to the electronic device 201 as indicated by reference numeral 1830. The processor 240 may output the information related to the application D, based on the information related to the application D received from the server 1501. For example, in the state where the first screen 505 of the application A and the second screen 510 of the application B are displayed on the display 231, the processor 240 may reconfigure and display the screens in the form of multiple windows to further display the third screen 515 of the application D. For example, in the state where the entire area of the display 231 is split into two areas, the processor 240 may reconfigure the areas as three split areas. The processor 240 may display the first screen 505 of the application A, the second screen 510 of the application B, and the third screen 515 of the application D in three split areas, respectively.

In an embodiment of the disclosure, the external electronic device 401 may end outputting of the information related to the application D. Further, the processor 240 may display the object 530 indicating at least one application (for example, the application H, the application I, and/or the application D) which can be executed in the external electronic device 401 instead of displaying at least one item for controlling functions related to the application D in the task bar area 520.

Referring to FIGS. 2, 3A to 3C, 4, 5A to 5D, 6A, 6B, 7A, 7B, 8, 9A to 9D, 10, 11A, 11B, 12A to 12C, 13A, 13B, 14A, 14B, 15, 16A to 16D, 17, and 18A to 18C according to various embodiments of the disclosure, the electronic device 201 may display the controller (for example, at least one item) for controlling at least one functions of the application being executed in the external electronic devices 401 and 1101 in the task bar area 520 of the display 231, so as to intuitively control at least one function of the application being executed in the external electronic devices 401 and 1101. Accordingly, the user may resolve cumbersomeness of directly controlling the external electronic devices 401 and 1101 to control at least one function of the application being executed in the external electronic devices 401 and 1101 while using the electronic device 201.

A method of controlling the external electronic device by the electronic device 201 according to an embodiment of the disclosure may include an operation of displaying, in the task bar area 520 of the display, a row of a first set of objects indicating a plurality of applications executable by the electronic device 201, detecting, through a communication circuit 210, the external electronic device 401 in proximity to the electronic device 201, based on detecting the external electronic device 401, connecting with the external electronic device 401 through communication, identifying an application which can be executed by the external electronic device 401, displaying, in the task bar area 520 of a display 231, a second object indicating the application which is executable by the external electronic device (401), receiving an input for the second object, and based on the input, transmitting information related to the application corresponding to the second object to the external electronic device 401 through the communication circuit 210.

The method of controlling the external electronic device by the electronic device 201 according to an embodiment may include an operation of displaying, on the display 231, an execution screen of a second application, displaying a home button in the task bar area 520 together with displaying of the row of the first set of the objects and the second object, wherein the task bar area 520 according to an embodiment may be located between the execution screen of the second application and a bottom edge of the display 231.

The method of controlling the external electronic device by the electronic device 201 according to an embodiment may include an operation of displaying, adjacent to the second object, at least one item for controlling at least one function of the application.

The operation of displaying the second object according to an embodiment may include an operation of displaying, in case that the second object indicates a multimedia player application, user interface items for controlling functions of the multimedia player application to be adjacent to the second object.

The method of controlling the external electronic device by the electronic device 201 according to an embodiment may include an operation of identifying a plurality of applications which is executable on the external electronic device 401, selecting, based on a predefined condition, a subset of the plurality of applications which are executable on the external electronic device 401, and displaying, in the task bar area 520 of the display 231, a row of second objects indicating the selected subset of the plurality of applications which are executable on the external electronic device 401.

The predefined condition for selecting the subset of the plurality of applications according to an embodiment may include a type of information to be output by the external electronic device 401 according to a type of the external electronic device 401.

The method of controlling the external electronic device by the electronic device 201 according to an embodiment may include an operation of identifying whether a first user input is detected on at least one item displayed in the task bar area 520 of the display 231. The method of controlling the external electronic device by the electronic device 201 according to an embodiment may include an operation of, in case that the first user input is detected, displaying information related to the application being output from the external electronic device 401 on the display 231 in a popup form. The method of controlling the external electronic device by the electronic device 201 according to an embodiment may include an operation of identifying whether a second user input is detected on the information displayed in the popup form and related to the application being output from the external electronic device 401 in the popup form. The method of controlling the external electronic device by the electronic device 201 according to an embodiment may include an operation of, in case that the second user input is detected, entering a multi-window arrangement mode.

The method of controlling the external electronic device by the electronic device 201 according to an embodiment may include an operation of identifying whether a third user input is detected on the information displayed in the popup form and related to the application being output from the external electronic device 401 displayed in the popup form after entering the multi-window arrangement mode. The method of controlling the external electronic device by the electronic device 201 according to an embodiment may include an operation of, in case that the third user input is detected, transmitting a signal for requesting transmission of the information related to the application being output in the external electronic device 401 to the external electronic device 401. The method of controlling the external electronic device by the electronic device 201 according to an embodiment may include an operation of receiving the information related to the application being output in the external electronic device 401 from the external electronic device 401 through the communication circuit 210 in response to the signal for requesting the transmission. The method of controlling the external electronic device by the electronic device 201 according to an embodiment may include an operation of outputting the information related to the application, based on the received information related to the application being output in the external electronic device 401.

The method of controlling the external electronic device by the electronic device 201 according to an embodiment may include an operation of identifying whether a fourth user input is detected in the execution screen of the second application being displayed on the display 231 after entering the multi-window arrangement mode. The method of controlling the external electronic device by the electronic device 201 according to an embodiment may include an operation of, in case that the fourth user input is detected, transmitting the information related to the second application to the external electronic device 401 through the communication circuit 210. The method of controlling the external electronic device by the electronic device 201 according to an embodiment may include an operation of displaying the object indicating the second application and at least one item for controlling at least one function related to the second application in the task bar area 520 of the display 231.

The method of controlling the external electronic device by the electronic device 201 according to an embodiment may include an operation of, in case that the fourth user input is detected, identifying whether the second application is an application supported by the external electronic device 401. The method of controlling the external electronic device by the electronic device 201 according to an embodiment may include an operation of, in case that the second application is identified as the application supported by the external electronic device 401, applying a first visual effect to the information related to the application being output from the external electronic device 401 displayed in the popup form and display the information. The method of controlling the external electronic device by the electronic device 201 according to an embodiment may include an operation of, in case that the second application is identified as an application which is not supported by the external electronic device 401, applying a second visual effect to the information related to the application being output from the external electronic device 401 displayed in the popup form and display the information.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., through wires), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment of the disclosure, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment of the disclosure, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments of the disclosure, each component (e.g., a module or a program) of the above-described components may include a single entity or multiple entities, and some of the multiple entities may be separately disposed in different components. According to various embodiments of the disclosure, one or more of the above-described components may be omitted, or one or more other components may be added. Alternatively or additionally, a plurality of components (e.g., modules or programs) may be integrated into a single component. In such a case, according to various embodiments of the disclosure, the integrated component may still perform one or more functions of each of the plurality of components in the same or similar manner as they are performed by a corresponding one of the plurality of components before the integration. According to various embodiments of the disclosure, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a communication circuit;
a display;
memory storing one or more computer programs; and
one or more processors communicatively coupled to the communication circuit, the display, and the memory,
wherein the one or more computer programs include computer-executable instructions that, when executed by the one or more processors, cause the electronic device to:
display, in a task bar area of the display, a row of a first set of objects indicating a plurality of applications executable by the electronic device,
detect, through the communication circuit, an external electronic device in proximity to the electronic device,
based on detecting the external electronic device, connect with the external electronic device through communication,
identify an application which is executable by the external electronic device,
display, in the task bar area of the display, a second object indicating the application which is executable by the external electronic device,
receive an input relating to the second object, and
based on the input, transmit information related to the application corresponding to the second object to the external electronic device through the communication circuit.

2. The electronic device of claim 1,
wherein the one or more computer programs further include computer-executable instructions that, when executed by the one or more processors, cause the electronic device to:
display, on the display, an execution screen of a second application, and
display a home button in the task bar area together with displaying of the row of the first set of the objects and the second object, and
wherein the task bar area is located between the execution screen of the second application and a bottom edge of the display.

3. The electronic device of claim 2, wherein the one or more computer programs further include computer-executable instructions that, when executed by the one or more processors, cause the electronic device to display, adjacently to the second object, at least one item for controlling at least one function of the application.

4. The electronic device of claim 3, wherein the one or more computer programs further include computer-executable instructions that, when executed by the one or more processors, cause the electronic device to, in case that the second object indicates a multi-media player application, display, adjacently to the second object, user interface items for controlling functions of the multi-media player application.

5. The electronic device of claim 1, wherein the one or more computer programs further include computer-executable instructions that, when executed by the one or more processors, cause the electronic device to:
identify a plurality of applications which is executable on the external electronic device,
select, based on a predefined condition, a subset of the plurality of applications which are executable on the external electronic device, and
display, in the task bar area of the display, a row of second objects indicating the selected subset of the plurality of applications which are executable on the external electronic device.

6. The electronic device of claim 5, wherein the predefined condition for selecting the subset of the plurality of applications includes a type of information to be output by the external electronic device according to a type of the external electronic device.

7. The electronic device of claim 3, wherein the one or more computer programs further include computer-executable instructions that, when executed by the one or more processors, cause the electronic device to:
identify whether a first user input is detected on the at least one item displayed in the task bar area of the display,
in case that the first user input is detected, display, on the display, in a popup form, information related to the application being output from the external electronic device,
identify whether a second user input is detected on the information displayed in the popup form and related to the application being output from the external electronic device, and
in case that the second user input is detected, enter a multi-window arrangement mode.

8. The electronic device of claim 7, wherein the one or more computer programs further include computer-executable instructions that, when executed by the one or more processors, cause the electronic device to:
after entering the multi-window arrangement mode, identify whether a third user input is detected on the information displayed in a popup form and related to the application being output from the external electronic device,
in case that the third user input is detected, transmit, to the external electronic device, a signal for requesting transmission of the information related to the application being output in the external electronic device,
in response to the signal for requesting the transmission, receive the information related to the application being output in the external electronic device from the external electronic device through the communication circuit, and
output the information related to the application, based on the received information related to the application being output in the external electronic device.

9. The electronic device of claim 7, wherein the one or more computer programs further include computer-executable instructions that, when executed by the one or more processors, cause the electronic device to:
after entering the multi-window arrangement mode, identify whether a fourth user input is detected in the execution screen of the second application being displayed on the display,
in case that the fourth user input is detected, transmit information related to the second application to the external electronic device through the communication circuit, and
display, in the task bar area of the display, an object indicating the second application and at least one item for controlling at least one function related to the second application.

10. The electronic device of claim 9, wherein the one or more computer programs further include computer-executable instructions that, when executed by the one or more processors, cause the electronic device to:
in case that the fourth user input is detected, identify whether the second application is an application supported by the external electronic device,
in case that the second application is identified as the application supported by the external electronic device, apply a first visual effect to the information displayed in the popup form and related to the application being output from the external electronic device, and display the information, and
in case that the second application is identified as an application which is not supported by the external electronic device, apply a second visual effect to the information displayed in the popup form and related to the application being output by the external electronic device, and display the information.

11. A method of controlling an external electronic device by an electronic device, the method comprising:
displaying, in a task bar area of a display, a row of a first set of objects indicating a plurality of applications executable by the electronic device;
detecting, through a communication circuit, the external electronic device in proximity to the electronic device;
based on detecting the external electronic device, connecting with the external electronic device through communication;
identifying an application which is executable by the external electronic device;
displaying, in the task bar area of the display, a second object indicating the application which is executable by the external electronic device;
receiving an input for the second object; and
based on the input, transmitting information related to the application corresponding to the second object to the external electronic device through the communication circuit.

12. The method of claim 11, further comprising:
displaying, on the display, an execution screen of a second application; and
displaying a home button in the task bar area together with displaying of the row of the first set of the objects and the second object,
wherein the task bar area is located between the execution screen of the second application and a bottom edge of the display.

13. The method of claim 11, further comprising:
displaying, adjacently to the second object, at least one item for controlling at least one function of the application.

14. The method of claim 13, wherein the displaying of the second object comprises displaying, in case that the second object indicates a multi-media player application, user interface items for controlling functions of the multi-media player application to be adjacent to the second object.

15. The method of claim 11, further comprising:
identifying a plurality of applications which is executable on the external electronic device;
selecting, based on a predefined condition, a subset of the plurality of applications which are executable on the external electronic device; and
displaying, in the task bar area of the display, a row of second objects indicating the selected subset of the plurality of applications which are executable on the external electronic device, and wherein the predefined condition for selecting the subset of the plurality of applications includes a type of information to be output by the external electronic device according to a type of the external electronic device.

16. The method of claim 13, further comprising:
identifying whether a first user input is detected on the at least one item displayed in the task bar area of the display;
in case that the first user input is detected, displaying, on the display, in a popup form, information related to the application being output from the external electronic device;
identifying whether a second user input is detected on the information displayed in the popup form and related to the application being output from the external electronic device; and
in case that the second user input is detected, entering a multi-window arrangement mode.

17. The method of claim 16, further comprising:
after entering the multi-window arrangement mode, identifying whether a third user input is detected on the information displayed in a popup form and related to the application being output from the external electronic device;
in case that the third user input is detected, transmitting, to the external electronic device, a signal for requesting transmission of the information related to the application being output in the external electronic device;
in response to the signal for requesting the transmission, receiving the information related to the application being output in the external electronic device from the external electronic device through the communication circuit; and
outputting the information related to the application, based on the received information related to the application being output in the external electronic device.

18. The method of claim 16, further comprising:
after entering the multi-window arrangement mode, identifying whether a fourth user input is detected in the execution screen of the second application being displayed on the display;
in case that the fourth user input is detected, transmitting information related to the second application to the external electronic device through the communication circuit; and
displaying an object indicating the second application and at least one item for controlling at least one function related to the second application in the task bar area of the display.

19. The method of claim 18, further comprising:
in case that the fourth user input is detected, identifying whether the second application is an application supported by the external electronic device;
in case that the second application is identified as the application supported by the external electronic device, applying a first visual effect to the information displayed in the popup form and related to the application being output from the external electronic device, and displaying the information; and
in case that the second application is identified as an application which is not supported by the external electronic device, applying a second visual effect to the information displayed in the popup form and related to the application being output from the external electronic device, and displaying the information.

20. One or more non-transitory computer-readable storage media storing computer-executable instructions that, when executed by one or more processors of an electronic device, cause the electronic device to perform operations, the operations comprising:
displaying, in a task bar area of a display, a row of a first set of objects indicating a plurality of applications executable by the electronic device;
detecting, through a communication circuit, an external electronic device in proximity to the electronic device;
based on detecting the external electronic device, connecting with the external electronic device through communication;
identifying an application which is executable by the external electronic device;
displaying, in the task bar area of the display, a second object indicating the application which is executable by the external electronic device;
receiving an input for the second object; and
based on the input, transmitting information related to the application corresponding to the second object to the external electronic device through the communication circuit.
